(19) United States
(12) Patent Application Publication
(10) Pub. No.: US 2026/0082312 A1
(43) Pub. Date: Mar. 19, 2026

(54) FEATURE-SPECIFIC ON-DEMAND SYSTEM INFORMATION FOR WIRELESS COMMUNICATIONS

(71) Applicant: QUALCOMM Incorporated, San Diego, CA (US)

(72) Inventors: Ahmed BEDEWY, Hillsborough, NJ (US); Naeem AKL, BRIDGEWATER, NJ (US); Navid ABEDINI, Basking Ridge, NJ (US); Jianghong LUO, Skillman, NJ (US)

(21) Appl. No.: 18/890,549

(22) Filed: Sep. 19, 2024

(51) Int. Cl. H04W 48/16; H04W 52/02

(52) U.S. Cl. CPC H04W 48/16; H04W 52/0229

(57) ABSTRACT

Methods, systems, and devices for wireless communications are described. In some examples, a user equipment (UE) may transmit a system information (SI) request to an anchor cell. The SI request may include a request for a first type of SI and may indicate a UE feature associated with the first type of SI. A distributed unit (DU) of the anchor cell may obtain and forward the request to a central unit (CU) of the anchor cell. The CU may receive the SI request and may output a transmission request instructing the DU to transmit the first type of SI. The DU may output the first type of SI in response to receiving the transmission request. For example, the DU may output the first type of SI to a radio unit (RU) of the anchor cell, which may transmit the first type of SI to the UE.

### FIELD OF TECHNOLOGY

The following relates to wireless communications, including feature-specific on-demand system information for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

In some wireless communications systems, devices may implement network energy savings (NES) techniques. For example, a NES anchor cell may transmit a system information block (SIB) to a user equipment (UE) based on receiving an on-demand request for the SIB from the UE. The anchor cell may transmit an entire SIB to the UE, which may include information associated with multiple different UE features or types. However, the UE may be associated with a UE feature that only corresponds to a portion of the SIB. That is, a first portion of the SIB may include information that is relevant to the UE, but a second portion of the SIB (e.g., the remainder of the SIB) may include information that is irrelevant to the UE. It may be beneficial to selectively transmit SI that includes a portion of a SIB having information associated with the UE to save power at the anchor cell for transmitting the SI and to save power at the UE for receiving the SI.

In some examples, a UE may transmit a request for SI to an anchor cell. The request for SI may include a request for a first type of SI and may indicate a UE feature. The UE feature may be associated with the UE and with the first type of SI. A distributed unit (DU) of the anchor cell may obtain the request and forward the request to a central unit (CU) of the anchor cell, including both the request for the first type of SI and the indication of the UE feature. The CU may receive the request for SI and instruct the DU to output the first type of SI in accordance with the request for SI. The DU may output the first type of SI in response to receiving the transmission request. In some cases, the UE may request multiple types of SI, which may be associated with the same UE feature or with different UE features.

A method for wireless communications by a first network node is described. The method may include obtaining a first message from a user equipment (UE), where the first message requests a first type of system information (SI) and indicates a UE feature, the UE feature associated with a first portion of the first type of SI, outputting, to a second network node in response to obtaining the first message associated with the UE, a second message that requests the first type of SI and indicates the UE feature, obtaining, from the second network node in response to outputting the second message, a transmission request message that indicates for the first network node to output the first portion of the first type of SI that is associated with the UE feature, and outputting, to the UE in response to receiving the transmission request message from the second network node, the first portion of the first type of SI that is associated with the UE feature.

A first network node for wireless communications is described. The first network node may include one or more memories storing processor executable code, and one or more processors coupled with the one or more memories. The one or more processors may individually or collectively be operable to execute the code to cause the first network node to obtain a first message from a UE, where the first message requests a first type of SI and indicates a UE feature, the UE feature associated with a first portion of the first type of SI, output, to a second network node in response to obtaining the first message associated with the UE, a second message that requests the first type of SI and indicates the UE feature, obtain, from the second network node in response to outputting the second message, a transmission request message that indicates for the first network node to output the first portion of the first type of SI that is associated with the UE feature, and output, to the UE in response to receiving the transmission request message from the second network node, the first portion of the first type of SI that is associated with the UE feature.

Another first network node for wireless communications is described. The first network node may include means for obtaining a first message from a UE, where the first message requests a first type of SI and indicates a UE feature, the UE feature associated with a first portion of the first type of SI, means for outputting, to a second network node in response to obtaining the first message associated with the UE, a second message that requests the first type of SI and indicates the UE feature, means for obtaining, from the second network node in response to outputting the second message, a transmission request message that indicates for the first network node to output the first portion of the first type of SI that is associated with the UE feature, and means for outputting, to the UE in response to receiving the transmission request message from the second network node, the first portion of the first type of SI that is associated with the UE feature.

A non-transitory computer-readable medium storing code for wireless communications is described. The code may include instructions executable by one or more processors to obtain a first message from a UE, where the first message requests a first type of SI and indicates a UE feature, the UE feature associated with a first portion of the first type of SI, output, to a second network node in response to obtaining the first message associated with the UE, a second message that requests the first type of SI and indicates the UE feature, obtain, from the second network node in response to outputting the second message, a transmission request message that indicates for the first network node to output the first portion of the first type of SI that is associated with the UE feature, and output, to the UE in response to receiving the transmission request message from the second network node, the first portion of the first type of SI that is associated with the UE feature.

In some examples of the method, first network nodes, and non-transitory computer-readable medium described herein, the first message, the second message, or any combination thereof further indicates a second UE feature, the second UE feature associated with a second portion of the first type of SI or with a first portion of a second type of SI, the transmission request message further indicates for the first network node to output the second portion of the first type of SI that may be associated with the second UE feature, and the first network node further outputs, in response to obtaining the transmission request message from the second network node, the second portion of the first type of SI that may be associated with the second UE feature.

In some examples of the method, first network nodes, and non-transitory computer-readable medium described herein, the UE feature may be also associated with a first portion of a second type of SI, the transmission request message further indicates for the first network node to output the first portion of the second type of SI that may be associated with the UE feature, and the first network node further outputs, in response to obtaining the transmission request message from the second network node, the first portion of the second type of SI that may be associated with the UE feature.

In some examples of the method, first network nodes, and non-transitory computer-readable medium described herein, the first message, the second message, or any combination thereof indicates one or more requested SI types and also indicates one or more UE features, each of the one or more indicated UE features associated with a respective portion of at least one of the one or more requested SI types.

In some examples of the method, first network nodes, and non-transitory computer-readable medium described herein, the first message, the second message, or any combination thereof further indicates a second UE feature, the second UE feature also associated with the first portion of the first type of SI and obtaining the transmission request message that indicates for the first network node to output the first portion of the first type of SI may be in accordance with the first message, the second message, or any combination thereof indicating the UE feature and the second UE feature.

Some examples of the method, first network nodes, and non-transitory computer-readable medium described herein may further include operations, features, means, or instructions for obtaining an additional first message from a second UE, where the additional first message requests the first type of SI and indicates a second UE feature, the second UE feature associated with a second portion of the first type of SI, the second message further indicates the second UE feature in response to obtaining the additional first message from the second UE, the transmission request message further indicates for the first network node to output the second portion of the first type of SI that may be associated with the second UE feature, and the first network node further outputs, in response to obtaining the transmission request message from the second network node, the second portion of the first type of SI that may be associated with the second UE feature.

Some examples of the method, first network nodes, and non-transitory computer-readable medium described herein may further include operations, features, means, or instructions for outputting, prior to obtaining the first message, first SI associated with the first network node to the second network node and obtaining, prior to obtaining the first message, second SI associated with the second network node, where the first type of SI includes the first SI associated with the first network node, the second SI associated with the second network node, or any combination thereof.

In some examples of the method, first network nodes, and non-transitory computer-readable medium described herein, the transmission request message obtained from the second network node includes the first portion of the first type of SI that may be associated with the UE feature.

Some examples of the method, first network nodes, and non-transitory computer-readable medium described herein may further include operations, features, means, or instructions for obtaining one or more requests for SI associated with a second wireless cell, where the first network node may be associated with a first wireless cell and outputting a report to the second network node indicating information associated with the one or more requests.

In some examples of the method, first network nodes, and non-transitory computer-readable medium described herein, the first message, the second message, the transmission request message, or any combination thereof indicates an identifier (ID) associated with the UE.

In some examples of the method, first network nodes, and non-transitory computer-readable medium described herein, the first portion of the first type of SI includes SI associated with the first network node, the second network node, a third network node that may be different from the first network node and the second network node, or any combination thereof.

In some examples of the method, first network nodes, and non-transitory computer-readable medium described herein, the first network node outputs the first portion of the first type of SI that may be associated with the UE feature for unicast transmission, multicast transmission, broadcast transmission, or any combination thereof.

In some examples of the method, first network nodes, and non-transitory computer-readable medium described herein, the first message from the UE includes a message 3 (Msg3) of a random access procedure.

A method for wireless communications by a second network node is described. The method may include obtaining a message from a first network node that requests a first type of SI and indicates a UE feature, the UE feature associated with a first portion of the first type of SI and outputting, to the first network node in response to obtaining the first message, a transmission request message that indicates for the first network node to output the first portion of the first type of SI that is associated with the UE feature.

A second network node for wireless communications is described. The second network node may include one or more memories storing processor executable code, and one or more processors coupled with the one or more memories. The one or more processors may individually or collectively be operable to execute the code to cause the second network node to obtain a message from a first network node that requests a first type of SI and indicates a UE feature, the UE feature associated with a first portion of the first type of SI and output, to the first network node in response to obtaining the first message, a transmission request message that indicates for the first network node to output the first portion of the first type of SI that is associated with the UE feature.

Another second network node for wireless communications is described. The second network node may include means for obtaining a message from a first network node that requests a first type of SI and indicates a UE feature, the UE feature associated with a first portion of the first type of SI and means for outputting, to the first network node in response to obtaining the first message, a transmission request message that indicates for the first network node to output the first portion of the first type of SI that is associated with the UE feature.

A non-transitory computer-readable medium storing code for wireless communications is described. The code may include instructions executable by one or more processors to obtain a message from a first network node that requests a first type of SI and indicates a UE feature, the UE feature associated with a first portion of the first type of SI and output, to the first network node in response to obtaining the first message, a transmission request message that indicates for the first network node to output the first portion of the first type of SI that is associated with the UE feature.

In some examples of the method, second network nodes, and non-transitory computer-readable medium described herein, the first message further indicates a second UE feature, the second UE feature associated with a second portion of the first type of SI or with a first portion of a second type of SI and the transmission request message further indicates for the first network node to output the second portion of the first type of SI that may be associated with the second UE feature.

Some examples of the method, second network nodes, and non-transitory computer-readable medium described herein may further include operations, features, means, or instructions for obtaining, prior to obtaining the first message, first SI associated with the first network node from the first network node and outputting, prior to obtaining the first message, second SI associated with the second network node to the first network node, where the first type of SI includes the first SI associated with the first network node, the second SI associated with the second network node, or any combination thereof.

In some examples of the method, second network nodes, and non-transitory computer-readable medium described herein, the transmission request message output to the first network node includes the first portion of the first type of SI that may be associated with the UE feature.

Some examples of the method, second network nodes, and non-transitory computer-readable medium described herein may further include operations, features, means, or instructions for obtaining a report from the first network node indicating information associated with one or more requests obtained by the first network node for SI associated with a second wireless cell, where the first network node may be associated with a first wireless cell.

In some examples of the method, second network nodes, and non-transitory computer-readable medium described herein, the first message, the transmission request message, or any combination thereof indicates an ID associated with the UE.

A method for wireless communications by a UE is described. The method may include transmitting a Msg3 of a random access procedure to a first network node, where the Msg3 requests a first type of SI and indicates a UE feature, and where the UE feature is associated with a first portion of the first type of SI and receiving the first portion of the first type of SI in response to transmitting the Msg3.

A UE for wireless communications is described. The UE may include one or more memories storing processor executable code, and one or more processors coupled with the one or more memories. The one or more processors may individually or collectively be operable to execute the code to cause the UE to transmit a Msg3 of a random access procedure to a first network node, where the Msg3 requests a first type of SI and indicates a UE feature, and where the UE feature is associated with a first portion of the first type of SI and receive the first portion of the first type of SI in response to transmitting the Msg3.

Another UE for wireless communications is described. The UE may include means for transmitting a Msg3 of a random access procedure to a first network node, where the Msg3 requests a first type of SI and indicates a UE feature, and where the UE feature is associated with a first portion of the first type of SI and means for receiving the first portion of the first type of SI in response to transmitting the Msg3.

A non-transitory computer-readable medium storing code for wireless communications is described. The code may include instructions executable by one or more processors to transmit a Msg3 of a random access procedure to a first network node, where the Msg3 requests a first type of SI and indicates a UE feature, and where the UE feature is associated with a first portion of the first type of SI and receive the first portion of the first type of SI in response to transmitting the Msg3.

In some examples of the method, UEs, and non-transitory computer-readable medium described herein, the Msg3 indicates an ID associated with the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports feature-specific on-demand system information for wireless communications in accordance with one or more aspects of the present disclosure.

FIG. 2 shows an example of a network architecture that supports feature-specific on-demand system information for wireless communications in accordance with one or more aspects of the present disclosure.

FIG. 3 shows an example of a wireless communications system that supports feature-specific on-demand system information for wireless communications in accordance with one or more aspects of the present disclosure.

FIG. 4 shows an example of a process flow that supports feature-specific on-demand system information for wireless communications in accordance with one or more aspects of the present disclosure.

FIG. 5 shows an example of a process flow that supports feature-specific on-demand system information for wireless communications in accordance with one or more aspects of the present disclosure.

FIG. 6 shows an example of a process flow that supports feature-specific on-demand system information for wireless communications in accordance with one or more aspects of the present disclosure.

FIGS. 7 and 8 show block diagrams of devices that support feature-specific on-demand system information for wireless communications in accordance with one or more aspects of the present disclosure.

FIG. 9 shows a block diagram of a communications manager that supports feature-specific on-demand system information for wireless communications in accordance with one or more aspects of the present disclosure.

FIG. 10 shows a diagram of a system including a device that supports feature-specific on-demand system information for wireless communications in accordance with one or more aspects of the present disclosure.

FIGS. 11 and 12 show block diagrams of devices that support feature-specific on-demand system information for wireless communications in accordance with one or more aspects of the present disclosure.

FIG. 13 shows a block diagram of a communications manager that supports feature-specific on-demand system information for wireless communications in accordance with one or more aspects of the present disclosure.

FIG. 14 shows a diagram of a system including a device that supports feature-specific on-demand system information for wireless communications in accordance with one or more aspects of the present disclosure.

FIGS. 15 and 16 show block diagrams of devices that support feature-specific on-demand system information for wireless communications in accordance with one or more aspects of the present disclosure.

FIG. 17 shows a block diagram of a communications manager that supports feature-specific on-demand system information for wireless communications in accordance with one or more aspects of the present disclosure.

FIG. 18 shows a diagram of a system including a device that supports feature-specific on-demand system information for wireless communications in accordance with one or more aspects of the present disclosure.

FIGS. 19 through 21 show flowcharts illustrating methods that support feature-specific on-demand system information for wireless communications in accordance with one or more aspects of the present disclosure.

### DETAILED DESCRIPTION

In some wireless communications systems, devices may implement network energy savings (NES) techniques. For example, instead of broadcasting system information (SI), a NES anchor cell may transmit system information (e.g., a system information block (SIB)) to a user equipment (UE) based on receiving an on-demand request for the system information from the UE. The UE may transmit a wakeup signal (WUS) to the anchor cell to request the SI. In this way, the anchor cell may operate in a low-power state until the anchor cell receives a request for SI. The anchor cell may transmit an entire SIB to the UE, which may include information associated with multiple different UE features or types. However, the UE may be associated with a UE feature that only corresponds to a portion of the SIB. That is, a first portion of the SIB may include information that is relevant to the UE, but a second portion of the SIB (e.g., the remainder of the SIB) may include information that is irrelevant to the UE. In such cases, the UE may discard information that does not correspond to the UE feature associated with the UE. It may be beneficial to selectively transmit SI that includes a portion of a SIB having information associated with the UE to save power at the anchor cell for transmitting the SI and to save power at the UE for receiving the SI.

Various aspects of the present disclosure described herein relate to feature-specific on-demand system information for wireless communications. In some examples, a UE may transmit a request for SI to an anchor cell. The request for SI may include a request for a first type of SI and may indicate a UE feature. The UE feature may be associated with the UE and with the first type of SI. A distributed unit (DU) of the anchor cell may obtain the request and forward the request to a central unit (CU) of the anchor cell, including both the request for the first type of SI and the indication of the UE feature. The CU may receive the request for SI and instruct the DU to output SI in accordance with the request for SI. For example, the CU may output a transmission request to the DU instructing the DU to transmit the first type of SI. The DU may output the first type of SI in response to receiving the transmission request. For example, the DU may output the first type of SI to a radio unit (RU) of the anchor cell, which may transmit the first type of SI to the UE. In some cases, the UE may request multiple types of SI, which may be associated with the same UE feature or with different UE features.

Aspects of the disclosure are initially described in the context of wireless communications systems. Aspects of the disclosure are additionally described with reference to network architecture and process flows. Aspects of the disclosure are further illustrated by and described with reference to apparatus diagrams, system diagrams, and flowcharts that relate to feature-specific on-demand system information for wireless communications.

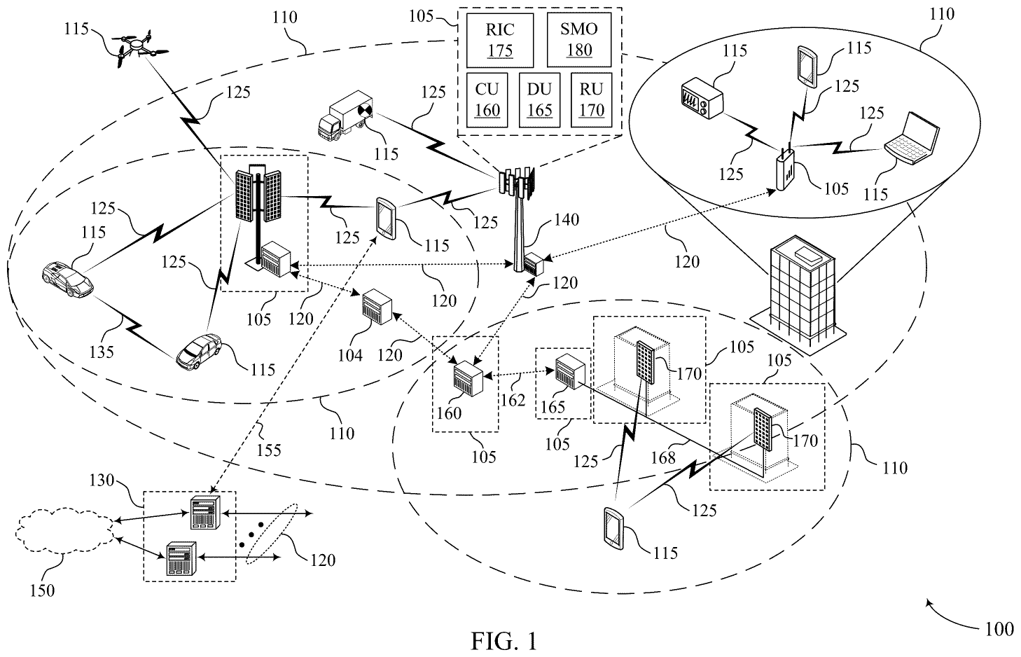

FIG. 1 shows an example of a wireless communications system 100 that supports feature-specific on-demand system information for wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support feature-specific on-demand system information for wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 may transmit an SI request message to an anchor cell. The SI request message may include a request for a first type of SI and may indicate a UE feature. The UE feature may be associated with the UE 115 and with the first type of SI. A DU 165 of the anchor cell may obtain the request and forward the request to a CU 160 of the anchor cell, including both the request for the first type of SI and the indication of the UE feature. The CU 160 may receive the request for SI and instruct the DU 165 to output SI in accordance with the request for SI. For example, the CU 160 may output a transmission request to the DU 165 instructing the DU 165 to transmit the first type of SI. The DU 165 may output the first type of SI in response to receiving the transmission request. For example, the DU 165 may output the first type of SI to a RU 170 of the anchor cell, which may transmit the first type of SI to the UE 115. In some cases, the UE 115 may request multiple types of SI, which may be associated with the same UE feature or with different UE features. In some cases, the DU 165 may receive multiple requests for different types of SI, either from the UE 115, from other UEs 115, or any combination thereof. In such cases, the DU 165 may indicate the multiple requested types of SI to the CU 160. The CU 160 may request for the DU 165 to transmit the multiple types of SI to the UE 115, to the other UEs 115, or both, in accordance with the multiple requests.

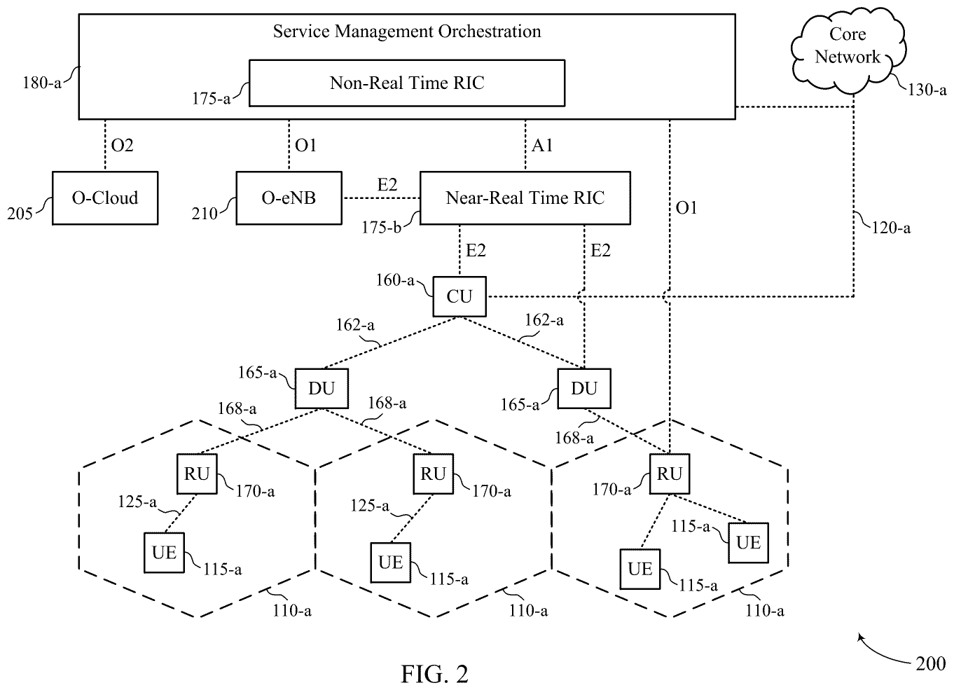

FIG. 2 shows an example of a network architecture 200 (e.g., a disaggregated base station architecture, a disaggregated RAN architecture) that supports feature-specific on-demand system information for wireless communications in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

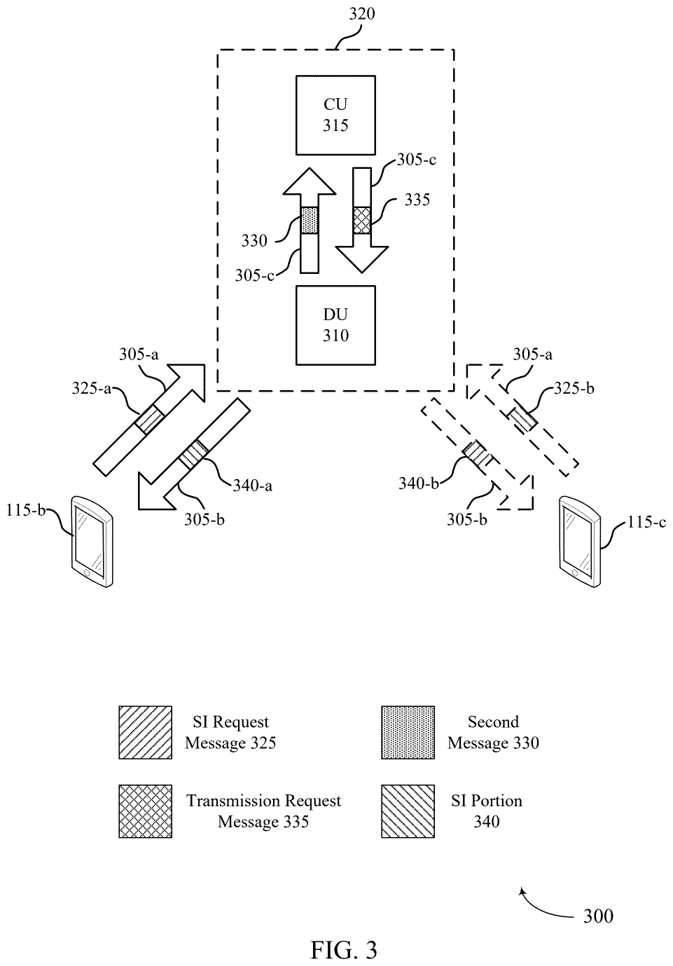

FIG. 3 shows an example of a wireless communications system 300 that supports feature-specific on-demand system information for wireless communications in accordance with one or more aspects of the present disclosure. The wireless communications system 300 may include a first UE 115-b and a second UE 115-c in communications with a DU 310 and a CU 315, which may be examples of corresponding devices described herein, including with reference to FIGS. 1 and 2. In some examples, the DU 310 and the CU 315 may be components of an anchor cell 320, which may be an example of a NES cell. In such examples, at least the first UE 115-b may be associated with (e.g., may support) NES communications for communicating with the anchor cell 320. The first UE 115-b and the second UE 115-c may communicate with the anchor cell 320 via communication links 305-a, which may be an example of an over-the-air link, such as an uplink, and via communication links 305-b, which may be an example of an over-the-air link, such as a backlink. The DU 310 and the CU 315 may communicate via communication links 305-c, which may be examples of backhaul links.

To establish communications, the UEs 115 and the anchor cell 320 may exchange SI. For example, the first UE 115-b may receive one or more SIBs from the anchor cell 320 (e.g., an RU of the anchor cell 320, not shown) for connecting with the anchor cell 320 (e.g., performing a random access procedure with the anchor cell 320). In some examples, the first UE 115-b may request SI from the anchor cell 320 on-demand. For example, if the anchor cell 320 is an NES cell, the first UE 115-b may use a WUS configuration to request a first SIB (e.g., SIB1) from the anchor cell 320. Additionally, or alternatively, the first UE 115-b may request other SI (OSI) different from the SIB1 on-demand. The first UE 115-b may utilize random access signaling to communicate the request for SI to the anchor cell 320. For example, the first UE 115-b may transmit an on-demand request for OSI using a random access channel (RACH) message protocol (e.g., using a RACH message 1 (Msg1), a RACH message 3 (Msg3)).

The anchor cell 320 may broadcast the SIB1 based on receiving the on-demand request from the first UE 115-b. The first UE 115-b may receive the SIB1 and may process the SIB1 to acquire SI that is relevant to the first UE 115-b. The first UE 115-b may discard SI that is not relevant to the first UE 115-b. For example, the SIB1 may include SI associated with different UE features or types, including at least SI associated with IAB-node UEs 115, SI associated with network-controlled repeater (NCR) UEs 115, SI associated with NES UEs 115, SI associated with small data transmission (SDT) UEs 115, SI associated with reduced capability (RedCap) UEs 115, or any combination thereof. However, the first UE 115-b may be associated with only some portion of the UE features included in the SIB1 and thus may acquire unnecessary (e.g., redundant or irrelevant) SI if the entire SIB1 is acquired. For example, if the first UE 115-b is an NES UE 115, the first UE 115-b may acquire the entire SIB1 and discard SI not related to NES UEs 115.

Various aspects of the present disclosure described herein relate to feature-specific on-demand system information for wireless communications. A DU 310 of an anchor cell 320 may receive a first message from the first UE 115-b. In some examples, the first message may be an SI request message 325 (e.g., a first SI request message 325-a) that includes both a request for a first type of SI and an indication of a first UE feature. The first UE feature may be associated with the first UE 115-b. For example, the first UE feature may indicate one or more capabilities of the UE. The first UE feature may be associated with the first type of SI or with a first portion of the first type of SI. In some examples, the first UE 115-b may transmit the first SI request message 325-a via a third message of a RACH procedure (e.g., a RACH Msg3).

The first UE 115-b may transmit the first SI request message 325-a to the anchor cell 320, where the DU 310 of the anchor cell 320 may obtain (e.g., receive) the first SI request message 325-a. The DU 310 may receive the first SI request message 325-a from an RU (not shown) of the anchor cell 320. Responsive to receiving the first SI request message 325-a, the DU 310 may transmit a second message 330 to the CU 315 of the anchor cell 320. In some examples, to transmit the second message 330, the DU 310 may forward (e.g., relay) the first SI request message 325-a received from the first UE 115-b to the CU 315. That is, the second message 330 may include both the requested SI and the first UE feature indicated by the first SI request message 325-a.

Responsive to receiving the second message 330 (e.g., the forwarded first SI request message 325-a) from the DU 310, the CU 315 may output (e.g., transmit, send) a transmission request message 335 to the DU 310. The transmission request message 335 may signal to (e.g., request for) the DU 310 to activate transmission of the first type of SI. If the CU 315 receives an indication of multiple requested types of SI and an associated multiple UE features via the forwarded SI request message 325, the CU 315 may request for the DU 310 to transmit the multiple requested types of SI via the transmission request message 335. The CU 315 may include an indication of the first UE feature indicated by the forwarded first SI request message 325-a in the transmission request message 335.

The DU 310 may output (e.g., transmit) the first type of SI based on receiving the transmission request message 335. The first type of SI may include an SI portion 340 which comprises some or all of the first type of SI in accordance with the first UE feature indicated by the first SI request message 325-a and the transmission request message 335. For example, the DU 310 may transmit a first SI portion 340-a to the first UE 115-b. The first SI portion 340-a may correspond to the SI requested by first SI request message 325-a. In some examples, the DU 310 may unicast, multicast, or broadcast the SI portion 340 (e.g., the first SI portion 340-a).

The DU 310 may receive requests for multiple types of SI. In some examples, the first UE 115-b may request the multiple types of SI via the first SI request message 325-a. For example, the first SI request message 325-a may include a request for the first type of SI and a second type of SI associated with a second UE feature. In some other examples, the first UE 115-b may request multiple types of SI via multiple SI request messages 325. For example, the first UE 115-b may transmit a SI request message 325 indicating a first UE feature at a first time. At a second time subsequent to the first time, the first UE 115-b may transmit an additional SI request message 325 indicating a second UE feature. Additionally, or alternatively, the DU 310 may receive additional SI request messages 325 from other UEs 115. For example, the DU 310 may receive a second SI request message 325-b from the second UE 115-c that includes both a request for a second type of SI and an indication of a second UE feature associated with the second type of SI. In some other examples, the DU 310 may receive a second SI request message 325-b from the second UE 115-c that includes both a request for the first type of SI and an indication of a second UE feature associated with a second portion of the first type of SI.

In some cases, the first type of SI and the second type of SI may be included in or otherwise associated with a same SIB. For example, the first type of SI may include a first portion of a SIB (e.g., SIB1) and the second type of SI may include a second portion of the same SIB (e.g., SIB1). Alternatively, the first type of SI and the second type of SI may be included in or otherwise associated with different SIBs. For example, the first type of SI may include a first portion of a first SIB (e.g., SIB1) and the second type of SI may include a second portion of a second SIB (e.g., SIB2).

In some cases, the SI request message 325 may include a list of requested SI. In such cases, each element of the list of requested SI may be associated with a UE feature. For example, the first UE 115-b may request both SIB5 (e.g., the first type of SI) and SIB6 (e.g., the second type of SI) via the first SI request message 325-a. The first SI request message 325-a may also include an indication of a RedCap UE feature such that the first SI request message 325-a indicates a request for RedCap SI from both SIB5 and SIB6. In another example, the first UE 115-b may request both SIB5 and SIB6 via the first SI request message 325-a. The first SI request message 325-a may also include an indication of a RedCap UE feature associated with SIB5 and an NES UE feature associated with SIB6 such that the first SI request message 325-a indicates a request for RedCap SI from SIB5 and NES SI from SIB6.

In such cases where the DU 310 receives multiple requests for different types of SI, the DU 310 may indicate the multiple requests via the second message 330. For example, if the DU 310 receives one or more SI request messages 325 for both the first type of SI and the second type of SI (e.g., from the first UE 115-b, from both the first UE 115-b and the second UE 115-c), the DU 310 may indicate both the first type of SI and the second type of SI, as well as a respective UE feature associated with each type of SI, in the second message 330.

In some examples, the SI request message 325 may include a UE-identifier (ID) to indicate which UE 115 transmitted the SI request message 325. For example, the first SI request message 325-a may include a first UE-ID associated with the first UE 115-b, and the second SI request message 325-b may include a second UE-ID associated with the second UE 115-c. In such examples, the DU 310 may also include (e.g., forward) the first UE-ID associated with the first SI request message 325-a and the second UE-ID associated with the second SI request message 325-b in the second message 330. If the CU 315 receives the second message 330 that includes a UE-ID, the transmission request message 335 transmitted by the CU 315 may also include the same UE-ID.

In cases where the DU 310 receives a transmission request message 335 that indicates multiple types of SI, the DU 310 may transmit SI portions 340 based on the UE features indicated by the transmission request message 335 (e.g., the first UE feature, the second UE feature). For example, if the transmission request message 335 indicates for the DU 310 to transmit both the first type of SI and the second type of SI, the DU 310 may transmit the first SI portion 340-a and a second SI portion 340-b. The first SI portion 340-a may include the first type of SI and the second SI portion 340-b may include the second type of SI. In some examples as described herein, the first type of SI may comprise a first portion of a SIB and the second SI portion 340-b may include a second portion of the same SIB, or the first type of SI may comprise a portion of a first SIB and the second SI portion 340-b may include a portion of a second SIB.

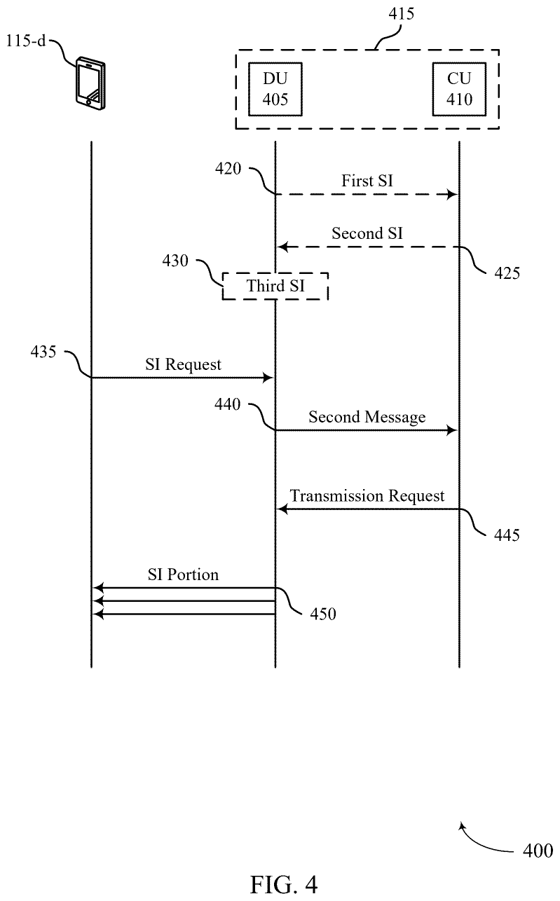

FIG. 4 shows an example of a process flow 400 that supports feature-specific on-demand system information for wireless communications in accordance with one or more aspects of the present disclosure. The process flow 400 may implement or be implemented by aspects of the wireless communications system 100, the network architecture 200, the wireless communications system 300, or any combination thereof, as described with reference to FIG. 1-3. For example, the process flow 400 may illustrate actions performed by a UE 115-d, a DU 405, and a CU 410, which may be examples of corresponding devices as described herein, including with reference to FIG. 1-3. For example, the DU 405 and the CU 410 may be components of an anchor cell 415. In the following description of the process flow 400, the operations between the UE 115-d, the DU 405, and the CU 410 may be performed in a different order than the example shown, or the operations between the UE 115-d, the DU 405, and the CU 410 may be performed in different orders at different times. Some operations may also be omitted from the process flow 400, and other operations may be added to the process flow 400.

In some examples, the DU 405 and the CU 410 may be associated with different system information. For example, the DU 405 may own (e.g., configure, control) a master information block (MIB) and the SIB1 for the anchor cell 415. Similarly, the CU 410 may own (e.g., configure, control) OSI, including SIB2, SIB3, SIB4, etc., for the anchor cell 415. Additionally, or alternatively, the anchor cell 415 may be in communications with a third network entity (e.g., a network node, a service, a core network). In some examples, the UE 115-d may request system information that is not associated with or otherwise available at the DU 405. For example, the UE 115-d may request a first type of SI that includes OSI (e.g., SIB2), but the DU 405 may be unable to transmit the first type of SI to the UE 115-d in response to the request. Accordingly, the DU 405 and the CU 410 may exchange SI such that the DU 405 acquires the SI associated with the CU 410. In some other examples, the UE 115-d may request SI that is not associated with or otherwise available at either the DU 405 or the CU 410, but is instead associated with a third network entity (not shown). Accordingly, the DU 405, the CU 410, and the third network node may exchange SI such that the DU 405 acquires the SI associated with both the CU 410 and the third network node.

In some examples, the DU 405 and the CU 410 may exchange SI prior to receiving an SI request from the UE 115-d requesting the first type of SI. For example, at 420, the DU 405 may transmit first SI associated with the DU 405 to the CU 410. At 425, the CU 410 may transmit second SI associated with the CU 410 to the DU 405. At 430, the DU 405 may receive third SI associated with the third network entity.

At 435, the UE 115-d may transmit the SI request as described herein with reference to FIG. 3. The SI request may request the first type of SI and may also indicate a first UE feature associated with the first type of SI. The first type of SI may be associated with the DU 405, the CU 410, or the third network entity. In some examples, the SI request may also request a second type of SI and a second UE feature associated with the second type of SI.

At 440, the DU 405 may transmit a second message to the CU 410 as described herein with reference to FIG. 3. In some examples, to transmit the second message, the DU 405 may forward or relay the SI request received from the UE 115-d to the CU 410. The second message may request the first type of SI and may also indicate the UE feature included in the SI request. In some other examples where the DU 405 and the CU 410 do not exchange SI before receiving the SI request from the UE 115-d, the second message may also indicate the first SI associated with the DU 405 to the CU 410.

At 445, the CU 410 may transmit a transmission request to the DU 405 responsive to receiving the second message as described herein with reference to FIG. 3. The transmission request may request or command the DU 405 to transmit the first type of SI requested by the UE 115-d. In some other examples where the DU 405 and the CU 410 do not exchange SI before receiving the SI request from the UE 115-d, the transmission request may also include the second SI associated with the CU 410. For example, the CU 410 may determine, based on the second message, that the first type of SI is associated with (e.g., available to) the CU 410 and is not associated with (e.g., unavailable to) the DU 405. If the CU 410 determines that the first type of SI is associated with the CU 410 but not with the DU 405, the CU 410 may include the first type of SI in the transmission request to the DU 405.

At 450, the DU 405 may transmit a SI portion to the UE 115-d in accordance with the transmission request and based on exchanging SI with the CU 410, the third network entity, or both. The SI portion may correspond to the first type of SI requested by the UE 115-d. In some examples, the DU 405 may transmit multiple SI portions to the UE 115-d based on the transmission request. For example, the transmission request may indicate for the DU 405 to transmit both a first type of SI and a second type of SI. In such cases, the DU 405 may transmit a first SI portion including the first type of SI (e.g., a portion of a first SIB, a first portion of a SIB) and a second SI portion including the second type of SI (e.g., a portion of a second SIB, a second portion of a SIB).

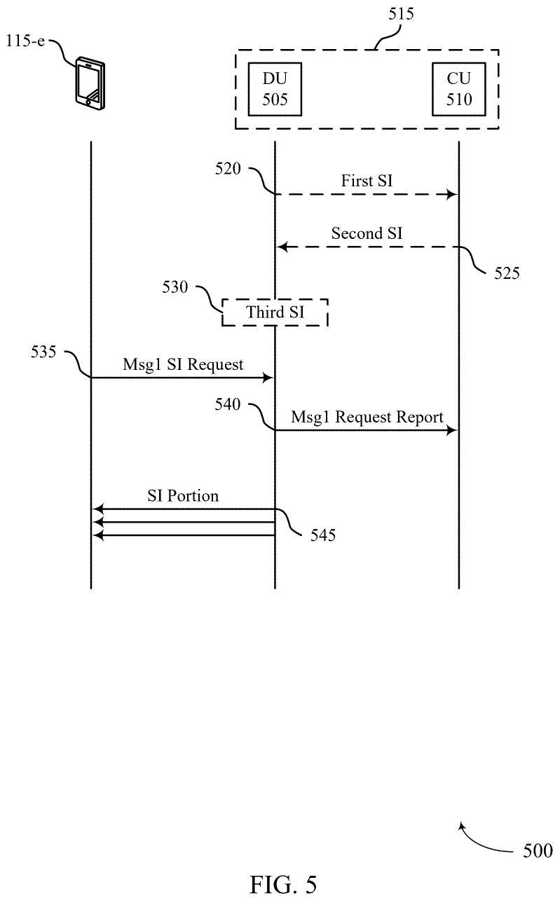

FIG. 5 shows an example of a process flow 500 that supports feature-specific on-demand system information for wireless communications in accordance with one or more aspects of the present disclosure. The process flow 500 may implement or be implemented by aspects of the wireless communications system 100, the network architecture 200, the wireless communications system 300, or any combination thereof, as described with reference to FIG. 1-3. For example, the process flow 500 may illustrate actions performed by a UE 115-e, a DU 505, and a CU 510, which may be examples of corresponding devices as described herein, including with reference to FIG. 1-3. For example, the DU 505 and the CU 510 may be components of an anchor cell 515, which may be an example of a NES cell as described with reference to FIG. 3. In the following description of the process flow 500, the operations between the UE 115-e, the DU 505, and the CU 510 may be performed in a different order than the example shown, or the operations between the UE 115-e, the DU 505, and the CU 510 may be performed in different orders at different times. Some operations may also be omitted from the process flow 500, and other operations may be added to the process flow 500.

In some examples, the DU 505 and the CU 510 may be associated with different system information. For example, the DU 505 may own (e.g., configure, control) a master information block (MIB) and the SIB1 for the anchor cell 515. Similarly, the CU 510 may own (e.g., configure, control) OSI, including SIB2, SIB3, SIB4, etc., for the anchor cell 515. In such examples, the DU 505 and the CU 510 may exchange SI prior to receiving an SI request from the UE 115-e requesting the first type of SI. For example, at 520, the DU 505 may transmit first SI associated with the DU 505 to the CU 510. At 525, the CU 510 may transmit second SI associated with the CU 510 to the DU 505. Additionally, or alternatively, the anchor cell 515 may be in communications with a third network entity, such as another anchor cell (e.g., another NES cell). In such cases, at 530, the DU 505 may receive third SI associated with the other NES cell (not shown).

In some examples, the UE 115-e may request system information that is not associated with or otherwise available at the DU 505. For example, the UE 115-e may request SI that is not associated with or otherwise available at either the DU 505 or the CU 510, but is instead associated with the other NES cell. At 535, the UE 115-e may transmit a RACH Msg1 to the DU 505 including a request for a first type of SI (e.g., a SIB1) that is associated with the other NES cell. The Msg1 SI request may include an indication of one or more UE features that are associated with the requested SI. The DU 505 may receive the Msg1 SI request from the UE 115-e. In some examples, the DU 505 may receive multiple Msg1 SI requests, either from the UE 115-e, from another one or more UEs, or any combination thereof.

At 540, the DU 505 may transmit a report about received Msg1 SI requests to the CU 510. The Msg1 request report may include information (e.g., statistical information) associated with Msg1 SI requests received by the DU 505. The CU 510 may operate or instruct the anchor cell 515 in accordance with the statistical information included in the Msg1 request report. For example, the Msg1 request report may indicate that the DU 505 is receiving a large quantity of requests for SI associated with other (e.g., neighboring) NES cells. In such cases, the anchor cell 515 may request the neighboring NES cells to deactivate some NES features. For example, the anchor cell 515 may request the neighboring NES cells to broadcast SI (e.g., broadcast SIB1 associated with the neighboring NES cells) instead of providing SI on-demand.

At 545, the DU 505 may transmit an SI portion to the UE 115-e in based on exchanging SI with the other NES cell. The SI portion may correspond to the first type of SI requested by the UE 115-e. In the example of FIG. 5 where the UE 115-e requests SI associated with the other NES cell via a RACH Msg1, the SI portion may include a portion of SI (e.g., a SIB1) associated with the other NES cell.

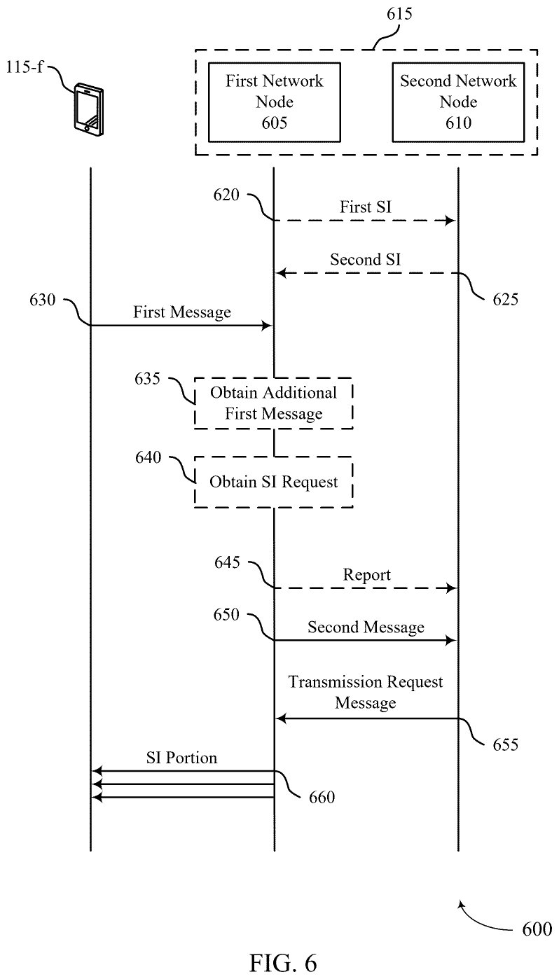

FIG. 6 shows an example of a process flow 600 that supports feature-specific on-demand system information for wireless communications in accordance with one or more aspects of the present disclosure. The process flow 600 may implement or be implemented by aspects of the wireless communications system 100, the network architecture 200, the wireless communications system 300, or any combination thereof, as described with reference to FIG. 1-3. For example, the process flow 600 may illustrate actions performed by a UE 115-f, a first network node 605, and a second network node 610, which may be examples of corresponding devices as described herein, including with reference to FIG. 1-3. For example, the first network node 605 may be an example of a DU and the second network node 610 may be an example of a CU as described with reference to FIG. 3. Both the first network node 605 and the second network node 610 may be components of an anchor cell 615, which may be an example of a NES cell as described with reference to FIG. 3. In the following description of the process flow 600, the operations between the UE 115-f, the first network node 605, and the second network node 610 may be performed in a different order than the example shown, or the operations between the UE 115-f, the first network node 605, and the second network node 610 may be performed in different orders at different times. Some operations may also be omitted from the process flow 600, and other operations may be added to the process flow 600.

At 620, the first network node 605 may output (e.g., transmit), prior to obtaining a first message from the UE 115-f, first SI associated with the first network node 605 to the second network node 610. The second network node 610 may obtain (e.g., receive) the first SI associated with the first network node 605 prior to obtaining a second message from the first network node 605 at 650.

At 625, the second network node 610 may output, prior to obtaining the first message, second SI associated with the second network node 610 to the first network node 605. A first type of SI (e.g., requested by the UE 115-f) may include the first SI associated with the first network node 605, the second SI associated with the second network node 610, or any combination thereof. The first network node 605 may obtain the second SI prior to obtaining the first message from the UE 115-f.

At 630, the first network node 605 may obtain a first message from the UE 115-f. The first message may request the first type of SI and may indicate a UE feature. Such a UE feature may be associated with a first portion of the first type of SI. In some examples, the first message from the UE 115-f may include a message 3 of a random access procedure. For example, the first message from the UE 115-f may be a Msg3 of a random access procedure to the first network node 605. The first portion of the first type of SI may include SI associated with the first network node 605, the second network node 610, a third network node (not shown) that is different from the first network node and the second network node, or any combination thereof. In some examples, the UE feature may also be associated with a first portion of a second type of SI.

At 635, the first network node 605 may obtain an additional first message from a second UE (not shown). In some examples, the additional first message may request the first type of SI and may indicate a second UE feature. In such examples, the second UE feature may be associated with a second portion of the first type of SI.

In some examples, the first network node may be associated with a first wireless cell. At 640, the first network node 605 may obtain one or more requests for SI associated with a second wireless cell (not shown). For example, the first network node 605 may receive one or more RACH Msg1 messages including requests for SI associated with the second wireless cell from a UE (e.g., the UE 115-f). In such examples, at 645 the first network node 605 may output a report to the second network node 610 indicating information associated with the one or more requests. For example, the report may include statistical information associated with the requests for SI associated with the second wireless cell received by the first network node 605.

At 650, the first network node 605 may output, to the second network node 610 in response to obtaining the first message associated with the UE 115-f, a second message that requests the first type of SI and indicates the UE feature. In some examples, the first network node 605 may forward (e.g., relay) the first message to the second network node 610. In some examples where the UE 115-f receives an additional first message that indicates the second UE feature, the second message may further indicate the second UE feature in response to obtaining the additional first message from the second UE.

In some examples, the first message, the second message, or any combination thereof may further indicate a second UE feature. In such examples, the second UE feature may be associated with the second portion of the first type of SI, a first portion of a second type of SI, or may also be associated with the first portion of the first type of SI. Additionally, or alternatively, the first message, the second message, or any combination thereof may indicate one or more requested SI types and may also indicate one or more UE features, where each of the one or more indicated UE features may be associated with a respective portion of at least one of the one or more requested SI types.

At 655, the second network node 610 may output, to the first network node 605 in response to obtaining the second message, a transmission request message that indicates for the first network node 605 to output the first portion of the first type of SI that is associated with the UE feature. In some examples, the first message, the second message, the transmission request message, or any combination thereof may indicate an identifier associated with the UE 115-f. Additionally, or alternatively, in some examples the transmission request message output to and obtained by the first network node 605 may include the first portion of the first type of SI that is associated with the UE feature.

In some examples where the UE feature included in the first message, the second message, or any combination thereof may also be associated with a first portion of a second type of SI, transmission request message may further indicate for the first network node 605 to output the first portion of the second type of SI that is associated with the UE feature. In some other examples where the first message, the second message, or any combination thereof further indicates the second UE feature that is associated with the second portion of the first type of SI, the transmission request message may further indicate for the first network node 605 to output the second portion of the first type of SI that is associated with the second UE feature.

Similarly, in some other examples where the first message, the second message, or any combination thereof further indicates the second UE feature that is also associated with the first portion of the first type of SI, the transmission request message may indicate for the first network node 605 to output the first portion of the first type of SI in accordance with the first message, the second message, or any combination thereof indicating the UE feature and the second UE feature. Additionally, or alternatively, in some examples where the second message indicates the second UE feature in response to obtaining the additional first message from the second UE, the transmission request message may further indicate for the first network node 605 to output the second portion of the first type of SI that is associated with the second UE feature.

At 660, the first network node 605 may output, to the UE 115-f in response to receiving the transmission request message from the second network node 610, the first portion of the first type of SI that is associated with the UE feature. In some examples, the first network node 605 may output the first portion of the first type of SI that is associated with the UE feature for unicast transmission, multicast transmission, broadcast transmission, or any combination thereof.

In some examples, the first network node 605 may further output, in response to obtaining the transmission request message from the second network node 610, the second portion of the first type of SI that is associated with the second UE feature. For example, the first network node 605 may transmit the second portion of the first type of SI in response to receiving the transmission request message further indicating for the first network node 605 to output the second portion of the first type of SI that is associated with the second UE feature.

In some other examples, the first network node 605 may further output, in response to obtaining the transmission request message from the second network node 610, the first portion of the second type of SI that is associated with the UE feature. For example, the first network node 605 may transmit the first portion of the second type of SI in response to receiving the transmission request message further indicating for the first network node 605 to output the first portion of the second type of SI that is associated with the second UE feature.

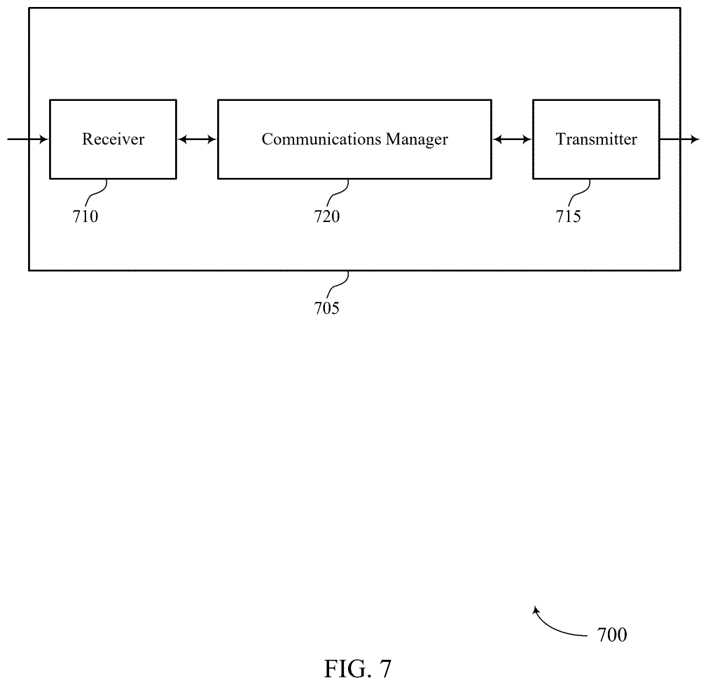

FIG. 7 shows a block diagram 700 of a device 705 that supports feature-specific on-demand system information for wireless communications in accordance with one or more aspects of the present disclosure. The device 705 may be an example of aspects of a first network node as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations or components thereof may be examples of means for performing various aspects of feature-specific on-demand system information for wireless communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for obtaining a first message from a UE, where the first message requests a first type of system information and indicates a UE feature, the UE feature associated with a first portion of the first type of system information. The communications manager 720 is capable of, configured to, or operable to support a means for outputting, to a second network node in response to obtaining the first message associated with the UE, a second message that requests the first type of system information and indicates the UE feature. The communications manager 720 is capable of, configured to, or operable to support a means for obtaining, from the second network node in response to outputting the second message, a transmission request message that indicates for the first network node to output the first portion of the first type of system information that is associated with the UE feature. The communications manager 720 is capable of, configured to, or operable to support a means for outputting, to the UE in response to receiving the transmission request message from the second network node, the first portion of the first type of system information that is associated with the UE feature.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced power consumption and more efficient utilization of communication resources.

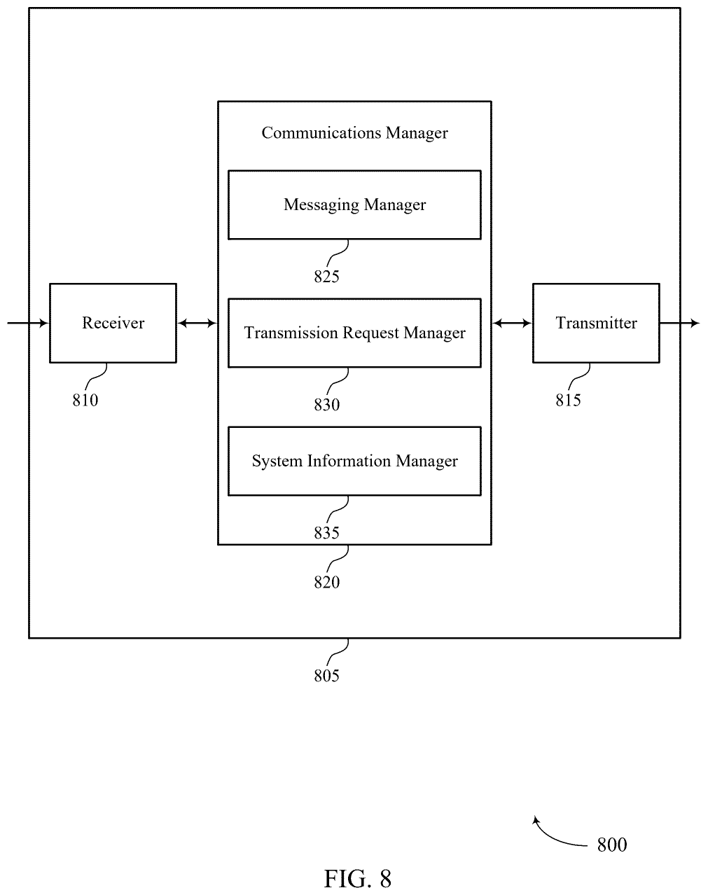

FIG. 8 shows a block diagram 800 of a device 805 that supports feature-specific on-demand system information for wireless communications in accordance with one or more aspects of the present disclosure. The device 805 may be an example of aspects of a device 705, a first network node 605, a DU 505, a DU 405, a DU 310, or a DU 165 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of feature-specific on-demand system information for wireless communications as described herein. For example, the communications manager 820 may include a messaging manager 825, a transmission request manager 830, a system information manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The messaging manager 825 is capable of, configured to, or operable to support a means for obtaining a first message from a UE, where the first message requests a first type of system information and indicates a UE feature, the UE feature associated with a first portion of the first type of system information. The messaging manager 825 is capable of, configured to, or operable to support a means for outputting, to a second network node in response to obtaining the first message associated with the UE, a second message that requests the first type of system information and indicates the UE feature. The transmission request manager 830 is capable of, configured to, or operable to support a means for obtaining, from the second network node in response to outputting the second message, a transmission request message that indicates for the first network node to output the first portion of the first type of system information that is associated with the UE feature. The system information manager 835 is capable of, configured to, or operable to support a means for outputting, to the UE in response to receiving the transmission request message from the second network node, the first portion of the first type of system information that is associated with the UE feature.

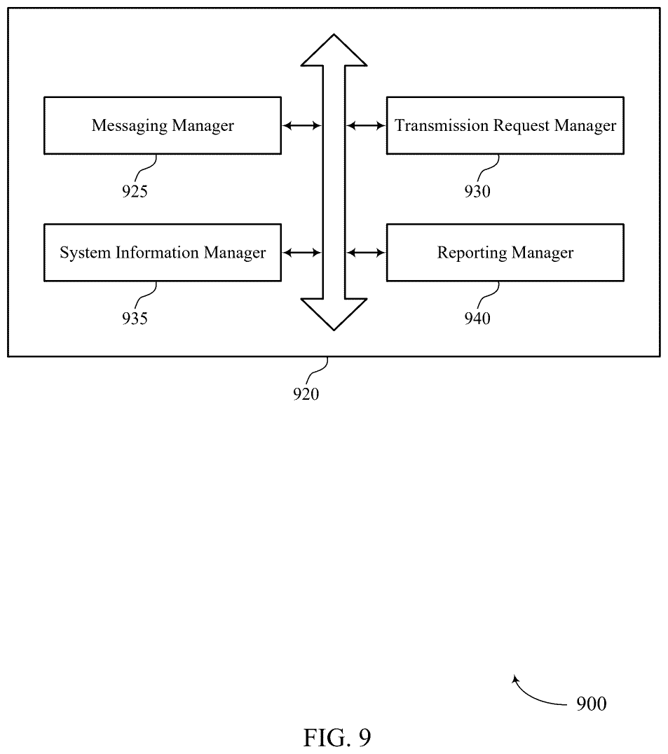

FIG. 9 shows a block diagram 900 of a communications manager 920 that supports feature-specific on-demand system information for wireless communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of feature-specific on-demand system information for wireless communications as described herein. For example, the communications manager 920 may include a messaging manager 925, a transmission request manager 930, a system information manager 935, a reporting manager 940, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The messaging manager 925 is capable of, configured to, or operable to support a means for obtaining a first message from a UE, where the first message requests a first type of system information and indicates a UE feature, the UE feature associated with a first portion of the first type of system information. In some examples, the messaging manager 925 is capable of, configured to, or operable to support a means for outputting, to a second network node in response to obtaining the first message associated with the UE, a second message that requests the first type of system information and indicates the UE feature. The transmission request manager 930 is capable of, configured to, or operable to support a means for obtaining, from the second network node in response to outputting the second message, a transmission request message that indicates for the first network node to output the first portion of the first type of system information that is associated with the UE feature. The system information manager 935 is capable of, configured to, or operable to support a means for outputting, to the UE in response to receiving the transmission request message from the second network node, the first portion of the first type of system information that is associated with the UE feature.

In some examples, the first message, the second message, or any combination thereof further indicates a second UE feature, the second UE feature associated with a second portion of the first type of system information or with a first portion of a second type of system information. In some examples, the transmission request message further indicates for the first network node to output the second portion of the first type of system information that is associated with the second UE feature. In some examples, the first network node further outputs, in response to obtaining the transmission request message from the second network node, the second portion of the first type of system information that is associated with the second UE feature.

In some examples, the UE feature is also associated with a first portion of a second type of system information. In some examples, the transmission request message further indicates for the first network node to output the first portion of the second type of system information that is associated with the UE feature. In some examples, the first network node further outputs, in response to obtaining the transmission request message from the second network node, the first portion of the second type of system information that is associated with the UE feature.

In some examples, the first message, the second message, or any combination thereof indicates one or more requested system information types and also indicates one or more UE features, each of the one or more indicated UE features associated with a respective portion of at least one of the one or more requested system information types.

In some examples, the first message, the second message, or any combination thereof further indicates a second UE feature, the second UE feature also associated with the first portion of the first type of system information. In some examples, obtaining the transmission request message that indicates for the first network node to output the first portion of the first type of system information is in accordance with the first message, the second message, or any combination thereof indicating the UE feature and the second UE feature.

In some examples, the messaging manager 925 is capable of, configured to, or operable to support a means for obtaining an additional first message from a second UE, where the additional first message requests the first type of system information and indicates a second UE feature, the second UE feature associated with a second portion of the first type of system information. In some examples, the second message further indicates the second UE feature in response to obtaining the additional first message from the second UE. In some examples, the transmission request message further indicates for the first network node to output the second portion of the first type of system information that is associated with the second UE feature. In some examples, the system information manager 935 is capable of, configured to, or operable to support a means for further outputting, in response to obtaining the transmission request message from the second network node, the second portion of the first type of system information that is associated with the second UE feature.

In some examples, the system information manager 935 is capable of, configured to, or operable to support a means for outputting, prior to obtaining the first message, first system information associated with the first network node to the second network node. In some examples, the system information manager 935 is capable of, configured to, or operable to support a means for obtaining, prior to obtaining the first message, second system information associated with the second network node, where the first type of system information includes the first system information associated with the first network node, the second system information associated with the second network node, or any combination thereof.

In some examples, the transmission request message obtained from the second network node includes the first portion of the first type of system information that is associated with the UE feature.

In some examples, the system information manager 935 is capable of, configured to, or operable to support a means for obtaining one or more requests for system information associated with a second wireless cell, where the first network node is associated with a first wireless cell. In some examples, the reporting manager 940 is capable of, configured to, or operable to support a means for outputting a report to the second network node indicating information associated with the one or more requests.

In some examples, the first message, the second message, the transmission request message, or any combination thereof indicates an identifier associated with the UE.

In some examples, the first portion of the first type of system information includes system information associated with the first network node, the second network node, a third network node that is different from the first network node and the second network node, or any combination thereof.

In some examples, the first network node outputs the first portion of the first type of system information that is associated with the UE feature for unicast transmission, multicast transmission, broadcast transmission, or any combination thereof.

In some examples, the first message from the UE is a Msg3 of a random access procedure.

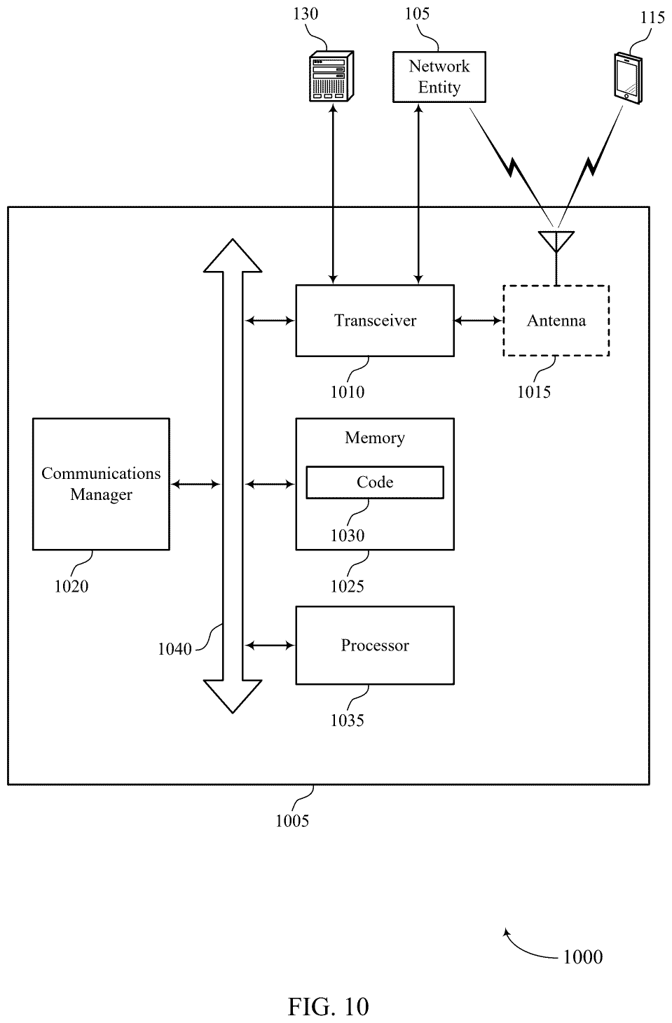

FIG. 10 shows a diagram of a system 1000 including a device 1005 that supports feature-specific on-demand system information for wireless communications in accordance with one or more aspects of the present disclosure. The device 1005 may be an example of or include components of a device 705, a device 805, or a first network node as described herein. The device 1005 may include components for bi-directional voice and data communications including components for transmitting and receiving communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting feature-specific on-demand system information for wireless communications). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005.

The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network entities 105, and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

The communications manager 1020 may support wireless communications in accordance with examples as disclosed herein. For example, the communications manager 1020 is capable of, configured to, or operable to support a means for obtaining a first message from a UE, where the first message requests a first type of system information and indicates a UE feature, the UE feature associated with a first portion of the first type of system information. The communications manager 1020 is capable of, configured to, or operable to support a means for outputting, to a second network node in response to obtaining the first message associated with the UE, a second message that requests the first type of system information and indicates the UE feature. The communications manager 1020 is capable of, configured to, or operable to support a means for obtaining, from the second network node in response to outputting the second message, a transmission request message that indicates for the first network node to output the first portion of the first type of system information that is associated with the UE feature. The communications manager 1020 is capable of, configured to, or operable to support a means for outputting, to the UE in response to receiving the transmission request message from the second network node, the first portion of the first type of system information that is associated with the UE feature.

By including or configuring the communications manager 1020 in accordance with examples as described herein, the device 1005 may support techniques for reduced latency and improved user experience related to reduced power consumption and more efficient utilization of communication resources

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of feature-specific on-demand system information for wireless communications as described herein, or the at least one processor 1035 and the at least one memory 1025 may be otherwise configured to, individually or collectively, perform or support such operations.

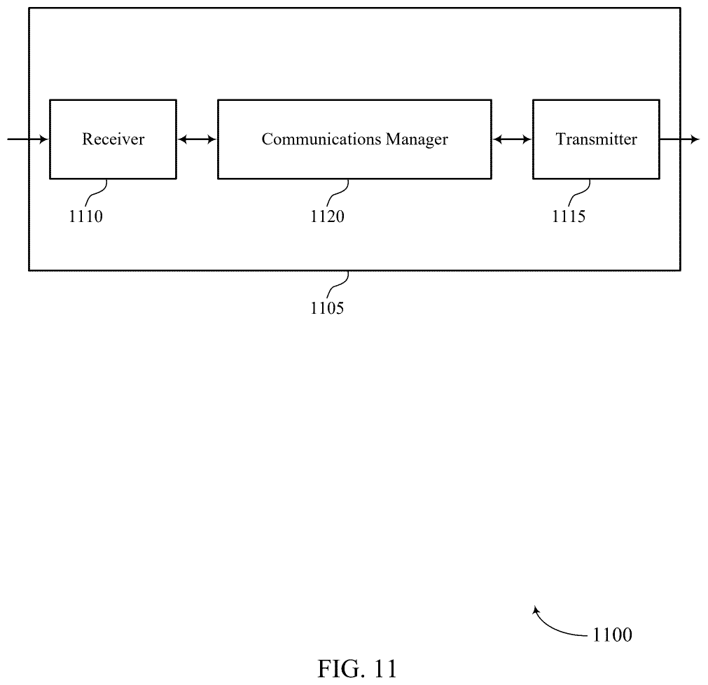

FIG. 11 shows a block diagram 1100 of a device 1105 that supports feature-specific on-demand system information for wireless communications in accordance with one or more aspects of the present disclosure. The device 1105 may be an example of aspects of a second network node as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to feature-specific on-demand system information for wireless communications). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to feature-specific on-demand system information for wireless communications). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of feature-specific on-demand system information for wireless communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for obtaining a message from a first network node that requests a first type of system information and indicates a UE feature, the UE feature associated with a first portion of the first type of system information. The communications manager 1120 is capable of, configured to, or operable to support a means for outputting, to the first network node in response to obtaining the first message, a transmission request message that indicates for the first network node to output the first portion of the first type of system information that is associated with the UE feature.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced power consumption and more efficient utilization of communication resources.

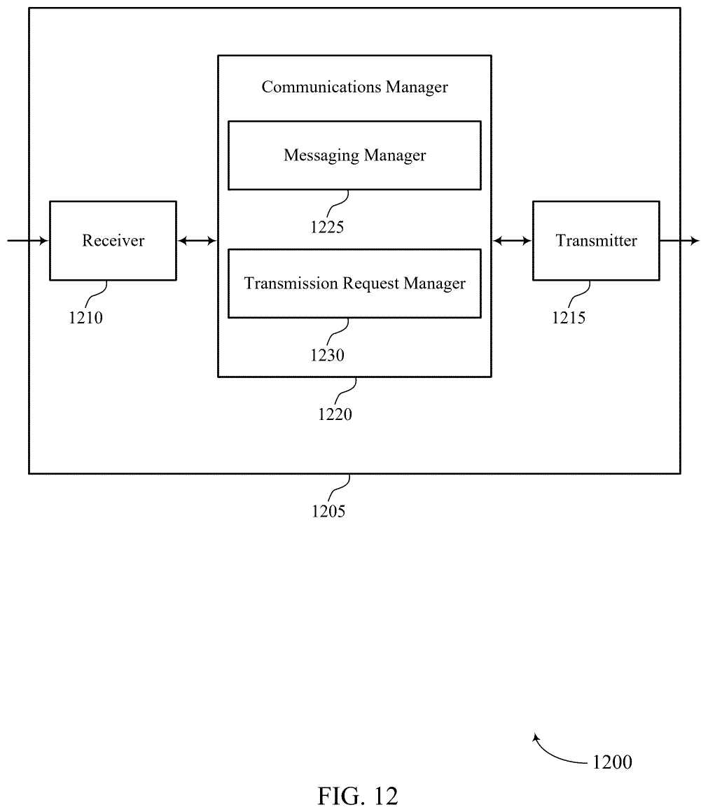

FIG. 12 shows a block diagram 1200 of a device 1205 that supports feature-specific on-demand system information for wireless communications in accordance with one or more aspects of the present disclosure. The device 1205 may be an example of aspects of a device 1105, a second network node 610, a CU 510, a CU 410, a CU 315, or a CU 160 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to feature-specific on-demand system information for wireless communications). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to feature-specific on-demand system information for wireless communications). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of feature-specific on-demand system information for wireless communications as described herein. For example, the communications manager 1220 may include a messaging manager 1225, a transmission request manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The messaging manager 1225 is capable of, configured to, or operable to support a means for obtaining a message from a first network node that requests a first type of system information and indicates a UE feature, the UE feature associated with a first portion of the first type of system information. The transmission request manager 1230 is capable of, configured to, or operable to support a means for outputting, to the first network node in response to obtaining the first message, a transmission request message that indicates for the first network node to output the first portion of the first type of system information that is associated with the UE feature.

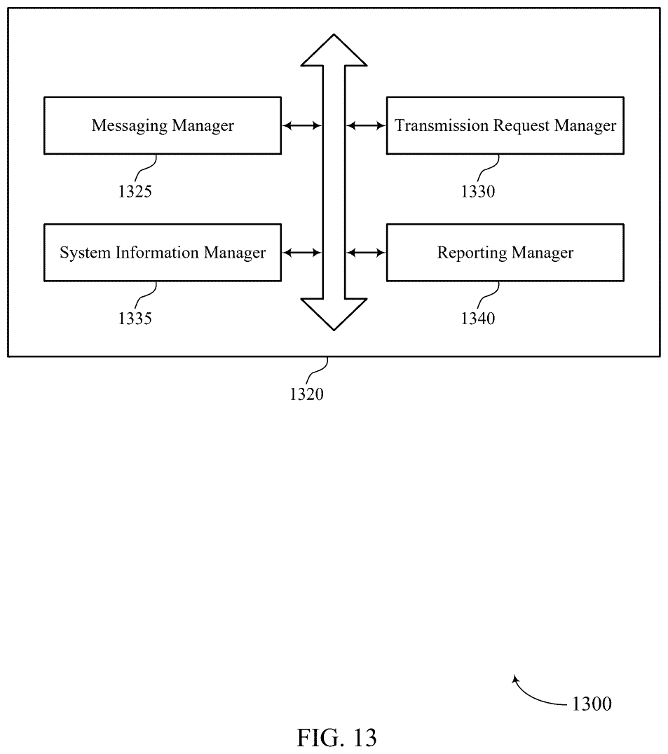

FIG. 13 shows a block diagram 1300 of a communications manager 1320 that supports feature-specific on-demand system information for wireless communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of feature-specific on-demand system information for wireless communications as described herein. For example, the communications manager 1320 may include a messaging manager 1325, a transmission request manager 1330, a system information manager 1335, a reporting manager 1340, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with examples as disclosed herein. The messaging manager 1325 is capable of, configured to, or operable to support a means for obtaining a message from a first network node that requests a first type of system information and indicates a UE feature, the UE feature associated with a first portion of the first type of system information. The transmission request manager 1330 is capable of, configured to, or operable to support a means for outputting, to the first network node in response to obtaining the first message, a transmission request message that indicates for the first network node to output the first portion of the first type of system information that is associated with the UE feature.

In some examples, the first message further indicates a second UE feature, the second UE feature associated with a second portion of the first type of system information or with a first portion of a second type of system information. In some examples, the transmission request message further indicates for the first network node to output the second portion of the first type of system information that is associated with the second UE feature.

In some examples, the system information manager 1335 is capable of, configured to, or operable to support a means for obtaining, prior to obtaining the first message, first system information associated with the first network node from the first network node. In some examples, the system information manager 1335 is capable of, configured to, or operable to support a means for outputting, prior to obtaining the first message, second system information associated with the second network node to the first network node, where the first type of system information includes the first system information associated with the first network node, the second system information associated with the second network node, or any combination thereof.

In some examples, the transmission request message output to the first network node includes the first portion of the first type of system information that is associated with the UE feature.

In some examples, the reporting manager 1340 is capable of, configured to, or operable to support a means for obtaining a report from the first network node indicating information associated with one or more requests obtained by the first network node for system information associated with a second wireless cell, where the first network node is associated with a first wireless cell.

In some examples, the first message, the transmission request message, or any combination thereof indicates an identifier associated with the UE.

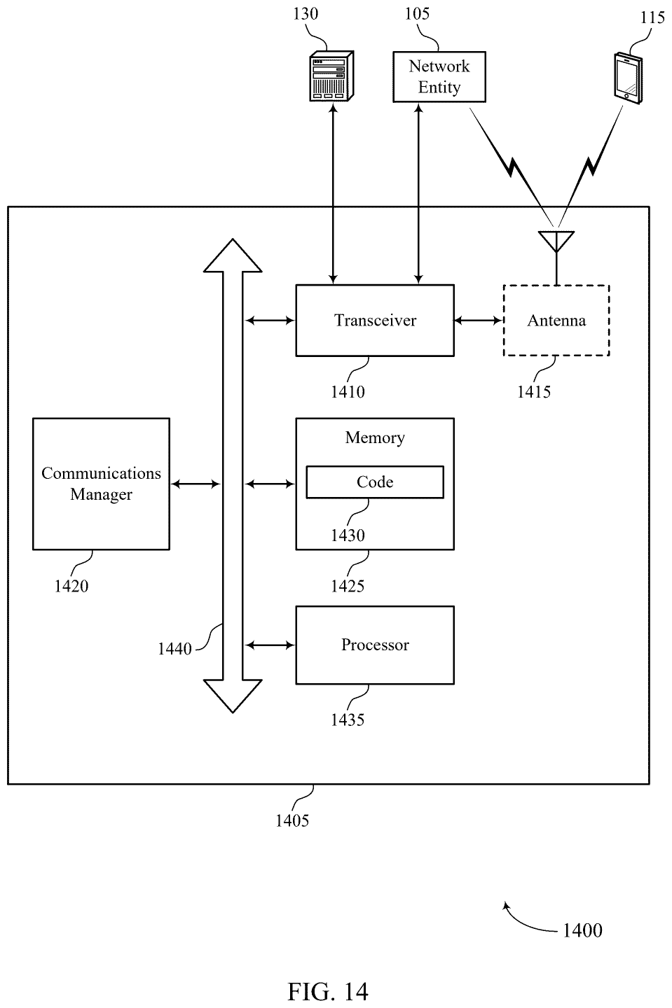

FIG. 14 shows a diagram of a system 1400 including a device 1405 that supports feature-specific on-demand system information for wireless communications in accordance with one or more aspects of the present disclosure. The device 1405 may be an example of or include components of a device 1105, a device 1205, or a second network node as described herein. The device 1405 may include components for bi-directional voice and data communications including components for transmitting and receiving communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

In some cases, the device 1405 may include a single antenna. However, in some other cases, the device 1405 may have more than one antenna, which may be capable of concurrently transmitting or receiving multiple wireless transmissions. The transceiver 1410 may communicate bi-directionally via the one or more antennas 1415 using wired or wireless links as described herein. For example, the transceiver 1410 may represent a wireless transceiver and may communicate bi-directionally with another wireless transceiver. The transceiver 1410 may also include a modem to modulate the packets, to provide the modulated packets to one or more antennas 1415 for transmission, and to demodulate packets received from the one or more antennas 1415. The transceiver 1410, or the transceiver 1410 and one or more antennas 1415, may be an example of a transmitter 1115, a transmitter 1215, a receiver 1110, a receiver 1210, or any combination thereof or component thereof, as described herein.

The at least one memory 1425 may include RAM and ROM. The at least one memory 1425 may store computer-readable, computer-executable, or processor-executable code, such as the code 1430. The code 1430 may include instructions that, when executed by the at least one processor 1435, cause the device 1405 to perform various functions described herein. The code 1430 may be stored in a non-transitory computer-readable medium such as system memory or another type of memory. In some cases, the code 1430 may not be directly executable by the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices.

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into the at least one processor 1435. The at least one processor 1435 may be configured to execute computer-readable instructions stored in a memory (e.g., the at least one memory 1425) to cause the device 1405 to perform various functions (e.g., functions or tasks supporting feature-specific on-demand system information for wireless communications). For example, the device 1405 or a component of the device 1405 may include at least one processor 1435 and at least one memory 1425 coupled with or to the at least one processor 1435, the at least one processor 1435 and the at least one memory 1425 configured to perform various functions described herein.

In some examples, the at least one processor 1435 may include multiple processors and the at least one memory 1425 may include multiple memories. One or more of the multiple processors may be coupled with one or more of the multiple memories, which may, individually or collectively, be configured to perform various functions described herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1430 (e.g., processor-executable code) stored in the at least one memory 1425 or otherwise, to perform one or more of the functions described herein.

The communications manager 1420 may support wireless communications in accordance with examples as disclosed herein. For example, the communications manager 1420 is capable of, configured to, or operable to support a means for obtaining a message from a first network node that requests a first type of system information and indicates a UE feature, the UE feature associated with a first portion of the first type of system information. The communications manager 1420 is capable of, configured to, or operable to support a means for outputting, to the first network node in response to obtaining the first message, a transmission request message that indicates for the first network node to output the first portion of the first type of system information that is associated with the UE feature.

By including or configuring the communications manager 1420 in accordance with examples as described herein, the device 1405 may support techniques for reduced latency and improved user experience related to reduced power consumption and more efficient utilization of communication resources

In some examples, the communications manager 1420 may be configured to perform various operations (e.g., receiving, monitoring, transmitting) using or otherwise in cooperation with the transceiver 1410, the one or more antennas 1415, or any combination thereof. Although the communications manager 1420 is illustrated as a separate component, in some examples, one or more functions described with reference to the communications manager 1420 may be supported by or performed by the at least one processor 1435, the at least one memory 1425, the code 1430, or any combination thereof. For example, the code 1430 may include instructions executable by the at least one processor 1435 to cause the device 1405 to perform various aspects of feature-specific on-demand system information for wireless communications as described herein, or the at least one processor 1435 and the at least one memory 1425 may be otherwise configured to, individually or collectively, perform or support such operations.

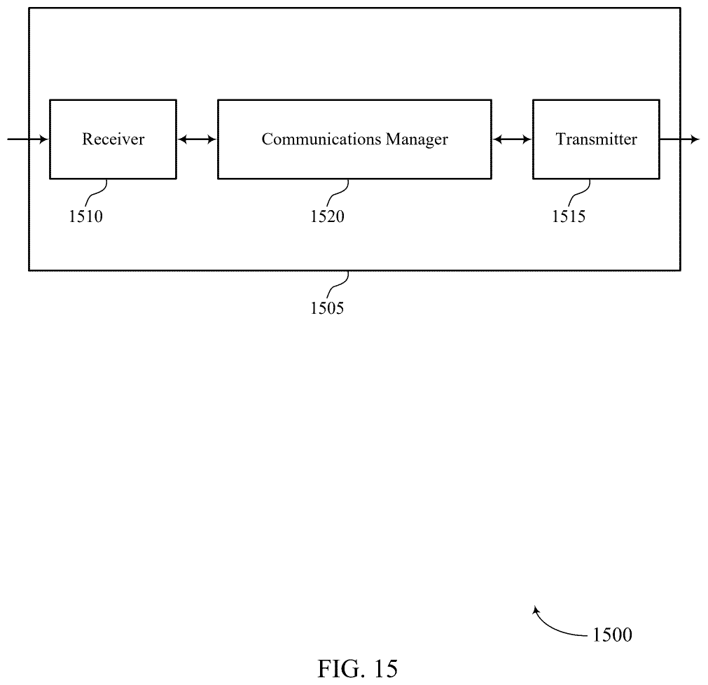

FIG. 15 shows a block diagram 1500 of a device 1505 that supports feature-specific on-demand system information for wireless communications in accordance with one or more aspects of the present disclosure. The device 1505 may be an example of aspects of a UE 115 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to feature-specific on-demand system information for wireless communications). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to feature-specific on-demand system information for wireless communications). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations or components thereof may be examples of means for performing various aspects of feature-specific on-demand system information for wireless communications as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for transmitting a Msg3 of a random access procedure to a first network node, where the Msg3 requests a first type of system information and indicates a UE feature, and where the UE feature is associated with a first portion of the first type of system information. The communications manager 1520 is capable of, configured to, or operable to support a means for receiving the first portion of the first type of system information in response to transmitting the Msg3.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for reduced power consumption and more efficient utilization of communication resources.

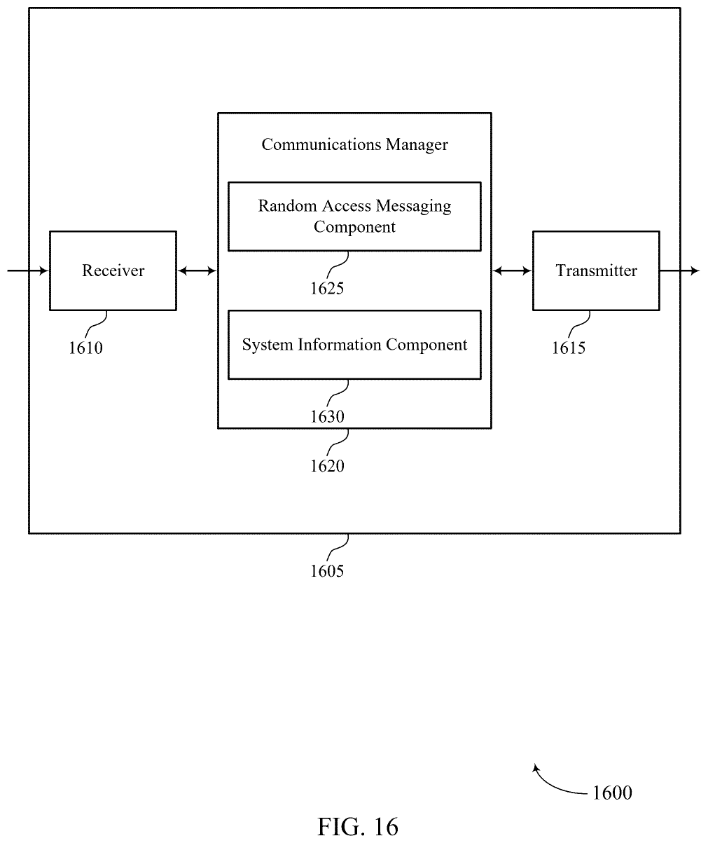

FIG. 16 shows a block diagram 1600 of a device 1605 that supports feature-specific on-demand system information for wireless communications in accordance with one or more aspects of the present disclosure. The device 1605 may be an example of aspects of a device 1505 or a UE 115 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for receiving information such as packets, user data, control information, or any combination thereof associated with various information channels (e.g., control channels, data channels, information channels related to feature-specific on-demand system information for wireless communications). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to feature-specific on-demand system information for wireless communications). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of feature-specific on-demand system information for wireless communications as described herein. For example, the communications manager 1620 may include a random access messaging component 1625 a system information component 1630, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The random access messaging component 1625 is capable of, configured to, or operable to support a means for transmitting a Msg3 of a random access procedure to a first network node, where the Msg3 requests a first type of system information and indicates a UE feature, and where the UE feature is associated with a first portion of the first type of system information. The system information component 1630 is capable of, configured to, or operable to support a means for receiving the first portion of the first type of system information in response to transmitting the Msg3.

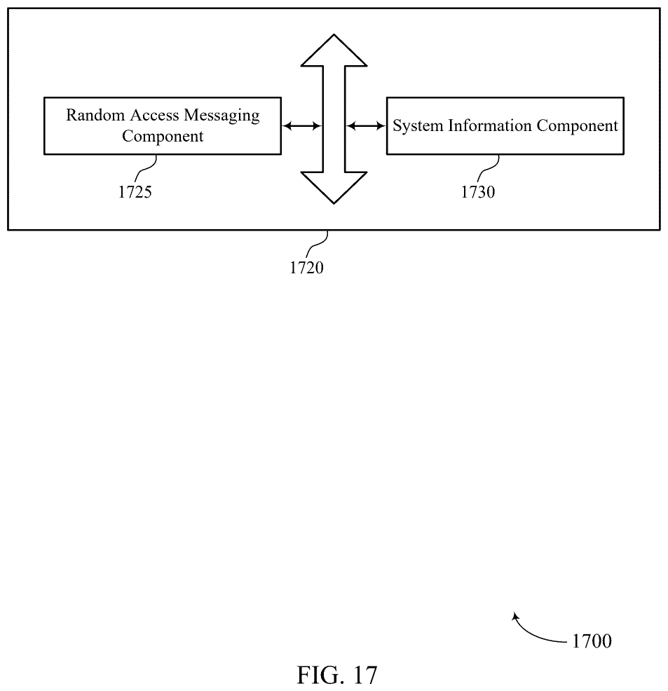

FIG. 17 shows a block diagram 1700 of a communications manager 1720 that supports feature-specific on-demand system information for wireless communications in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of feature-specific on-demand system information for wireless communications as described herein. For example, the communications manager 1720 may include a random access messaging component 1725 a system information component 1730, or any combination thereof. Each of these components, or components or subcomponents thereof (e.g., one or more processors, one or more memories), may communicate, directly or indirectly, with one another (e.g., via one or more buses).

The communications manager 1720 may support wireless communications in accordance with examples as disclosed herein. The random access messaging component 1725 is capable of, configured to, or operable to support a means for transmitting a Msg3 of a random access procedure to a first network node, where the Msg3 requests a first type of system information and indicates a UE feature, and where the UE feature is associated with a first portion of the first type of system information. The system information component 1730 is capable of, configured to, or operable to support a means for receiving the first portion of the first type of system information in response to transmitting the Msg3.

In some examples, the Msg3 indicates an identifier associated with the UE.

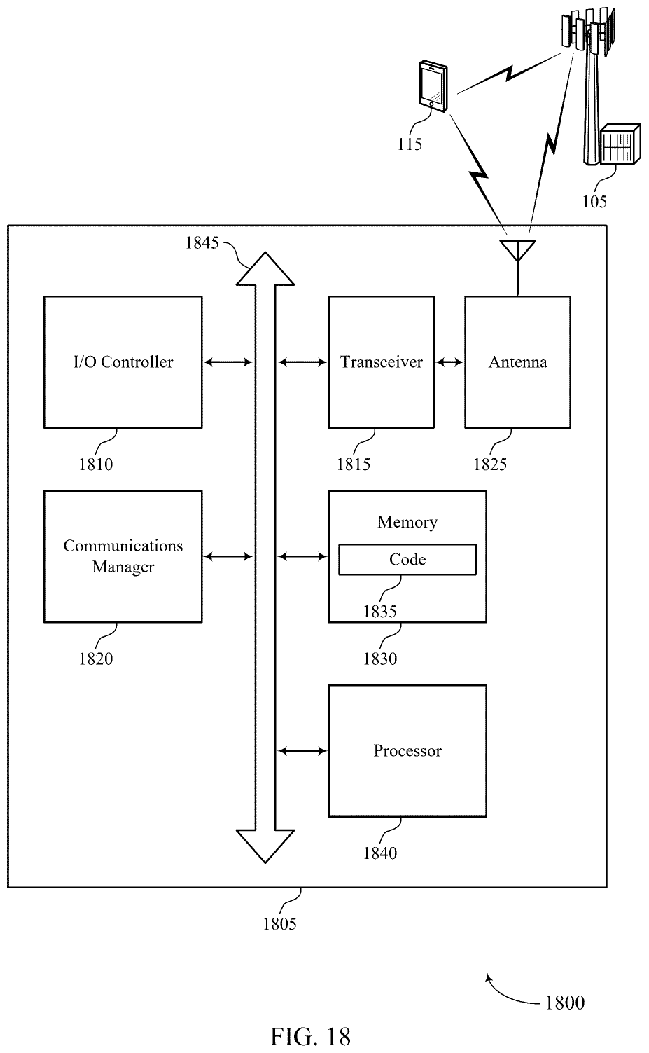

FIG. 18 shows a diagram of a system 1800 including a device 1805 that supports feature-specific on-demand system information for wireless communications in accordance with one or more aspects of the present disclosure. The device 1805 may be an example of or include components of a device 1505, a device 1605, or a UE 115 as described herein. The device 1805 may communicate (e.g., wirelessly) with one or more other devices (e.g., network entities 105, UEs 115, or a combination thereof). The device 1805 may include components for bi-directional voice and data communications including components for transmitting and receiving communications, such as a communications manager 1820, an input/output (I/O) controller, such as an I/O controller 1810, a transceiver 1815, one or more antennas 1825, at least one memory 1830, code 1835, and at least one processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®, UNIX®, LINUX®, or another known operating system. Additionally, or alternatively, the I/O controller 1810 may represent or interact with a modem, a keyboard, a mouse, a touchscreen, or a similar device. In some cases, the I/O controller 1810 may be implemented as part of one or more processors, such as the at least one processor 1840. In some cases, a user may interact with the device 1805 via the I/O controller 1810 or via hardware components controlled by the I/O controller 1810.

In some cases, the device 1805 may include a single antenna. However, in some other cases, the device 1805 may have more than one antenna, which may be capable of concurrently transmitting or receiving multiple wireless transmissions. The transceiver 1815 may communicate bi-directionally via the one or more antennas 1825 using wired or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The at least one memory 1830 may include random access memory (RAM) and read-only memory (ROM). The at least one memory 1830 may store computer-readable, computer-executable, or processor-executable code, such as the code 1835. The code 1835 may include instructions that, when executed by the at least one processor 1840, cause the device 1805 to perform various functions described herein. The code 1835 may be stored in a non-transitory computer-readable medium such as system memory or another type of memory. In some cases, the code 1835 may not be directly executable by the at least one processor 1840 but may cause a computer (e.g., when compiled and executed) to perform functions described herein. In some cases, the at least one memory 1830 may include, among other things, a basic I/O system (BIOS) which may control basic hardware or software operation such as the interaction with peripheral components or devices.

The at least one processor 1840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1840 may be configured to operate a memory array using a memory controller. In some other cases, a memory controller may be integrated into the at least one processor 1840. The at least one processor 1840 may be configured to execute computer-readable instructions stored in a memory (e.g., the at least one memory 1830) to cause the device 1805 to perform various functions (e.g., functions or tasks supporting feature-specific on-demand system information for wireless communications). For example, the device 1805 or a component of the device 1805 may include at least one processor 1840 and at least one memory 1830 coupled with or to the at least one processor 1840, the at least one processor 1840 and the at least one memory 1830 configured to perform various functions described herein.

In some examples, the at least one processor 1840 may include multiple processors and the at least one memory 1830 may include multiple memories. One or more of the multiple processors may be coupled with one or more of the multiple memories, which may, individually or collectively, be configured to perform various functions described herein. In some examples, the at least one processor 1840 may be a component of a processing system, which may refer to a system (such as a series) of machines, circuitry (including, for example, one or both of processor circuitry (which may include the at least one processor 1840) and memory circuitry (which may include the at least one memory 1830)), or components, that receives or obtains inputs and processes the inputs to produce, generate, or obtain a set of outputs. The processing system may be configured to perform one or more of the functions described herein. For example, the at least one processor 1840 or a processing system including the at least one processor 1840 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code 1835 (e.g., processor-executable code) stored in the at least one memory 1830 or otherwise, to perform one or more of the functions described herein.

The communications manager 1820 may support wireless communications in accordance with examples as disclosed herein. For example, the communications manager 1820 is capable of, configured to, or operable to support a means for transmitting a Msg3 of a random access procedure to a first network node, where the Msg3 requests a first type of system information and indicates a UE feature, and where the UE feature is associated with a first portion of the first type of system information. The communications manager 1820 is capable of, configured to, or operable to support a means for receiving the first portion of the first type of system information in response to transmitting the Msg3.

By including or configuring the communications manager 1820 in accordance with examples as described herein, the device 1805 may support techniques for reduced latency and improved user experience related to reduced power consumption and more efficient utilization of communication resources.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the at least one processor 1840, the at least one memory 1830, the code 1835, or any combination thereof. For example, the code 1835 may include instructions executable by the at least one processor 1840 to cause the device 1805 to perform various aspects of feature-specific on-demand system information for wireless communications as described herein, or the at least one processor 1840 and the at least one memory 1830 may be otherwise configured to, individually or collectively, perform or support such operations.

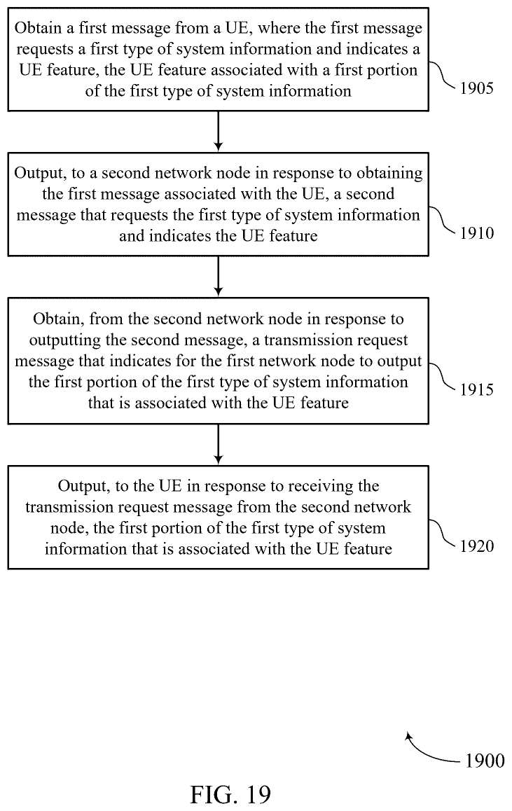

FIG. 19 shows a flowchart illustrating a method 1900 that supports feature-specific on-demand system information for wireless communications in accordance with one or more aspects of the present disclosure. The operations of the method 1900 may be implemented by a first network node or its components as described herein. For example, the operations of the method 1900 may be performed by a first network node as described with reference to FIGS. 1 through 10. In some examples, a first network node may execute a set of instructions to control the functional elements of the first network node to perform the described functions. Additionally, or alternatively, the first network node may perform aspects of the described functions using special-purpose hardware.

At 1905, the method may include obtaining a first message from a UE, where the first message requests a first type of system information and indicates a UE feature, the UE feature associated with a first portion of the first type of system information. The operations of 1905 may be performed in accordance with examples as disclosed herein. In some examples, aspects of the operations of 1905 may be performed by a messaging manager 925 as described with reference to FIG. 9.

At 1910, the method may include outputting, to a second network node in response to obtaining the first message associated with the UE, a second message that requests the first type of system information and indicates the UE feature. The operations of 1910 may be performed in accordance with examples as disclosed herein. In some examples, aspects of the operations of 1910 may be performed by a messaging manager 925 as described with reference to FIG. 9.

At 1915, the method may include obtaining, from the second network node in response to outputting the second message, a transmission request message that indicates for the first network node to output the first portion of the first type of system information that is associated with the UE feature. The operations of 1915 may be performed in accordance with examples as disclosed herein. In some examples, aspects of the operations of 1915 may be performed by a transmission request manager 930 as described with reference to FIG. 9.

At 1920, the method may include outputting, to the UE in response to receiving the transmission request message from the second network node, the first portion of the first type of system information that is associated with the UE feature. The operations of 1920 may be performed in accordance with examples as disclosed herein. In some examples, aspects of the operations of 1920 may be performed by a system information manager 935 as described with reference to FIG. 9.

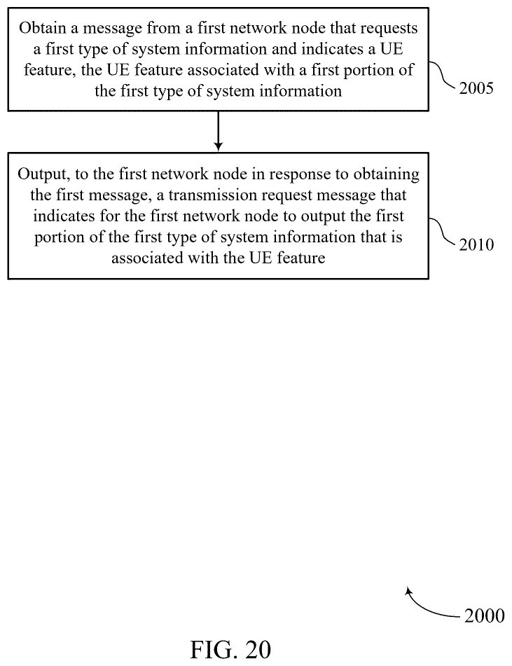

FIG. 20 shows a flowchart illustrating a method 2000 that supports feature-specific on-demand system information for wireless communications in accordance with one or more aspects of the present disclosure. The operations of the method 2000 may be implemented by a second network node or its components as described herein. For example, the operations of the method 2000 may be performed by a second network node as described with reference to FIGS. 1 through 6 and 11 through 14. In some examples, a second network node may execute a set of instructions to control the functional elements of the second network node to perform the described functions. Additionally, or alternatively, the second network node may perform aspects of the described functions using special-purpose hardware.

At 2005, the method may include obtaining a message from a first network node that requests a first type of system information and indicates a UE feature, the UE feature associated with a first portion of the first type of system information. The operations of 2005 may be performed in accordance with examples as disclosed herein. In some examples, aspects of the operations of 2005 may be performed by a messaging manager 1325 as described with reference to FIG. 13.

At 2010, the method may include outputting, to the first network node in response to obtaining the first message, a transmission request message that indicates for the first network node to output the first portion of the first type of system information that is associated with the UE feature. The operations of 2010 may be performed in accordance with examples as disclosed herein. In some examples, aspects of the operations of 2010 may be performed by a transmission request manager 1330 as described with reference to FIG. 13.

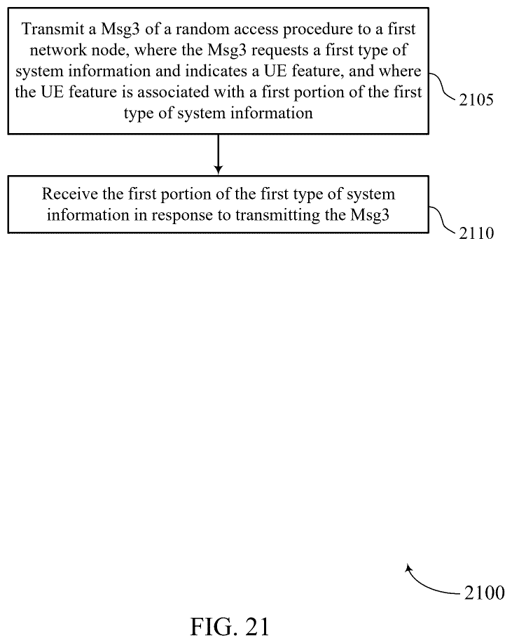

FIG. 21 shows a flowchart illustrating a method 2100 that supports feature-specific on-demand system information for wireless communications in accordance with one or more aspects of the present disclosure. The operations of the method 2100 may be implemented by a UE or its components as described herein. For example, the operations of the method 2100 may be performed by a UE 115 as described with reference to FIGS. 1 through 6 and 15 through 18. In some examples, a UE may execute a set of instructions to control the functional elements of the UE to perform the described functions. Additionally, or alternatively, the UE may perform aspects of the described functions using special-purpose hardware.

At 2105, the method may include transmitting a Msg3 of a random access procedure to a first network node, where the Msg3 requests a first type of system information and indicates a UE feature, and where the UE feature is associated with a first portion of the first type of system information. The operations of 2105 may be performed in accordance with examples as disclosed herein. In some examples, aspects of the operations of 2105 may be performed by a random access messaging component 1725 as described with reference to FIG. 17.

At 2110, the method may include receiving the first portion of the first type of system information in response to transmitting the Msg3. The operations of 2110 may be performed in accordance with examples as disclosed herein. In some examples, aspects of the operations of 2110 may be performed by a system information component 1730 as described with reference to FIG. 17.

The following provides an overview of aspects of the present disclosure:

Aspect 1: A method for wireless communications at a first network node, comprising: obtaining a first message from a UE, wherein the first message requests a first type of SI and indicates a UE feature, the UE feature associated with a first portion of the first type of SI; outputting, to a second network node in response to obtaining the first message associated with the UE, a second message that requests the first type of SI and indicates the UE feature; obtaining, from the second network node in response to outputting the second message, a transmission request message that indicates for the first network node to output the first portion of the first type of SI that is associated with the UE feature; and outputting, to the UE in response to receiving the transmission request message from the second network node, the first portion of the first type of SI that is associated with the UE feature.

Aspect 2: The method of aspect 1, wherein the first message, the second message, or any combination thereof further indicates a second UE feature, the second UE feature associated with a second portion of the first type of SI or with a first portion of a second type of SI; the transmission request message further indicates for the first network node to output the second portion of the first type of SI that is associated with the second UE feature; and the first network node further outputs, in response to obtaining the transmission request message from the second network node, the second portion of the first type of SI that is associated with the second UE feature.

Aspect 3: The method of any of aspects 1 through 2, wherein the UE feature is also associated with a first portion of a second type of SI; the transmission request message further indicates for the first network node to output the first portion of the second type of SI that is associated with the UE feature; and the first network node further outputs, in response to obtaining the transmission request message from the second network node, the first portion of the second type of SI that is associated with the UE feature.

Aspect 4: The method of any of aspects 1 through 3, wherein the first message, the second message, or any combination thereof indicates one or more requested SI types and also indicates one or more UE features, each of the one or more indicated UE features associated with a respective portion of at least one of the one or more requested SI types.

Aspect 5: The method of any of aspects 1 through 4, wherein the first message, the second message, or any combination thereof further indicates a second UE feature, the second UE feature also associated with the first portion of the first type of SI; and obtaining the transmission request message that indicates for the first network node to output the first portion of the first type of SI is in accordance with the first message, the second message, or any combination thereof indicating the UE feature and the second UE feature.

Aspect 6: The method of any of aspects 1 through 5, further comprising: obtaining an additional first message from a second UE, wherein the additional first message requests the first type of SI and indicates a second UE feature, the second UE feature associated with a second portion of the first type of SI; the second message further indicates the second UE feature in response to obtaining the additional first message from the second UE; the transmission request message further indicates for the first network node to output the second portion of the first type of SI that is associated with the second UE feature; and the first network node further outputs, in response to obtaining the transmission request message from the second network node, the second portion of the first type of SI that is associated with the second UE feature.

Aspect 7: The method of any of aspects 1 through 6, further comprising: outputting, prior to obtaining the first message, first SI associated with the first network node to the second network node; and obtaining, prior to obtaining the first message, second SI associated with the second network node, wherein the first type of SI comprises the first SI associated with the first network node, the second SI associated with the second network node, or any combination thereof.

Aspect 8: The method of any of aspects 1 through 7, wherein the transmission request message obtained from the second network node comprises the first portion of the first type of SI that is associated with the UE feature.

Aspect 9: The method of any of aspects 1 through 8, further comprising: obtaining one or more requests for SI associated with a second wireless cell, wherein the first network node is associated with a first wireless cell; and outputting a report to the second network node indicating information associated with the one or more requests.

Aspect 10: The method of any of aspects 1 through 9, wherein the first message, the second message, the transmission request message, or any combination thereof indicates an ID associated with the UE.

Aspect 11: The method of any of aspects 1 through 10, wherein the first portion of the first type of SI comprises SI associated with the first network node, the second network node, a third network node that is different from the first network node and the second network node, or any combination thereof.

Aspect 12: The method of any of aspects 1 through 11, wherein the first network node outputs the first portion of the first type of SI that is associated with the UE feature for unicast transmission, multicast transmission, broadcast transmission, or any combination thereof.

Aspect 13: The method of any of aspects 1 through 12, wherein the first message from the UE comprises a Msg3 of a random access procedure.

Aspect 14: A method for wireless communications at a second network node, comprising: obtaining a message from a first network node that requests a first type of SI and indicates a UE feature, the UE feature associated with a first portion of the first type of SI; and outputting, to the first network node in response to obtaining the first message, a transmission request message that indicates for the first network node to output the first portion of the first type of SI that is associated with the UE feature.

Aspect 15: The method of aspect 14, wherein the first message further indicates a second UE feature, the second UE feature associated with a second portion of the first type of SI or with a first portion of a second type of SI; and the transmission request message further indicates for the first network node to output the second portion of the first type of SI that is associated with the second UE feature.

Aspect 16: The method of any of aspects 14 through 15, further comprising: obtaining, prior to obtaining the first message, first SI associated with the first network node from the first network node; and outputting, prior to obtaining the first message, second SI associated with the second network node to the first network node, wherein the first type of SI comprises the first SI associated with the first network node, the second SI associated with the second network node, or any combination thereof.

Aspect 17: The method of any of aspects 14 through 16, wherein the transmission request message output to the first network node comprises the first portion of the first type of SI that is associated with the UE feature.

Aspect 18: The method of any of aspects 14 through 17, further comprising: obtaining a report from the first network node indicating information associated with one or more requests obtained by the first network node for SI associated with a second wireless cell, wherein the first network node is associated with a first wireless cell.

Aspect 19: The method of any of aspects 14 through 18, wherein the first message, the transmission request message, or any combination thereof indicates an associated with the UE.

Aspect 20: A method for wireless communications at a UE, comprising: transmitting a Msg3 of a random access procedure to a first network node, wherein the Msg3 requests a first type of SI and indicates a UE feature, and wherein the UE feature is associated with a first portion of the first type of SI; and receiving the first portion of the first type of SI in response to transmitting the Msg3.

Aspect 21: The method of aspect 20, wherein the Msg3 indicates an ID associated with the UE.

Aspect 22: A first network node for wireless communications, comprising one or more memories storing processor-executable code, and one or more processors coupled with the one or more memories and individually or collectively operable to execute the code to cause the first network node to perform a method of any of aspects 1 through 13.

Aspect 23: A first network node for wireless communications, comprising at least one means for performing a method of any of aspects 1 through 13.

Aspect 24: A non-transitory computer-readable medium storing code for wireless communications, the code comprising instructions executable by one or more processors to perform a method of any of aspects 1 through 13.

Aspect 25: A second network node for wireless communications, comprising one or more memories storing processor-executable code, and one or more processors coupled with the one or more memories and individually or collectively operable to execute the code to cause the second network node to perform a method of any of aspects 14 through 19.

Aspect 26: A second network node for wireless communications, comprising at least one means for performing a method of any of aspects 14 through 19.

Aspect 27: A non-transitory computer-readable medium storing code for wireless communications, the code comprising instructions executable by one or more processors to perform a method of any of aspects 14 through 19.

Aspect 28: A UE for wireless communications, comprising one or more memories storing processor-executable code, and one or more processors coupled with the one or more memories and individually or collectively operable to execute the code to cause the UE to perform a method of any of aspects 20 through 21.

Aspect 29: A UE for wireless communications, comprising at least one means for performing a method of any of aspects 20 through 21.

Aspect 30: A non-transitory computer-readable medium storing code for wireless communications, the code comprising instructions executable by one or more processors to perform a method of any of aspects 20 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. ”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components. ”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network node, comprising:
one or more memories storing processor-executable code; and
one or more processors coupled with the one or more memories and individually or collectively operable to execute the code to cause the first network node to:
obtain a first message from a user equipment (UE), wherein the first message requests a first type of system information and indicates a UE feature, the UE feature associated with a first portion of the first type of system information;
output, to a second network node in response to obtaining the first message associated with the UE, a second message that requests the first type of system information and indicates the UE feature;
obtain, from the second network node in response to outputting the second message, a transmission request message that indicates for the first network node to output the first portion of the first type of system information that is associated with the UE feature; and
output, to the UE in response to receiving the transmission request message from the second network node, the first portion of the first type of system information that is associated with the UE feature.

2. The first network node of claim 1, wherein:
the first message, the second message, or any combination thereof further indicates a second UE feature, the second UE feature associated with a second portion of the first type of system information or with a first portion of a second type of system information;
the transmission request message further indicates for the first network node to output the second portion of the first type of system information that is associated with the second UE feature; and
the one or more processors are individually or collectively further operable to execute the code to cause the first network node to output, in response to obtaining the transmission request message from the second network node, the second portion of the first type of system information that is associated with the second UE feature.

3. The first network node of claim 1, wherein:
the UE feature is also associated with a first portion of a second type of system information;
the transmission request message further indicates for the first network node to output the first portion of the second type of system information that is associated with the UE feature; and
the one or more processors are individually or collectively further operable to execute the code to cause the first network node to output, in response to obtaining the transmission request message from the second network node, the first portion of the second type of system information that is associated with the UE feature.

4. The first network node of claim 1, wherein the first message, the second message, or any combination thereof indicates one or more requested system information types and also indicates one or more UE features, each of the one or more indicated UE features associated with a respective portion of at least one of the one or more requested system information types.

5. The first network node of claim 1, wherein:
the first message, the second message, or any combination thereof further indicates a second UE feature, the second UE feature also associated with the first portion of the first type of system information; and
the one or more processors are individually or collectively operable to execute the code to cause the first network node to obtain the transmission request message that indicates for the first network node to output the first portion of the first type of system information in accordance with the first message, the second message, or any combination thereof indicating the UE feature and the second UE feature.

6. The first network node of claim 1, wherein:
the one or more processors are individually or collectively further operable to execute the code to cause the first network node to obtain an additional first message from a second UE, wherein the additional first message requests the first type of system information and indicates a second UE feature, the second UE feature associated with a second portion of the first type of system information;
the second message further indicates the second UE feature in response to the first network node obtaining the additional first message from the second UE;
the transmission request message further indicates for the first network node to output the second portion of the first type of system information that is associated with the second UE feature; and
the one or more processors are individually or collectively further operable to execute the code to cause the first network node to the first network node to output, in response to obtaining the transmission request message from the second network node, the second portion of the first type of system information that is associated with the second UE feature.

7. The first network node of claim 1, wherein the one or more processors are individually or collectively further operable to execute the code to cause the first network node to:
output, prior to obtaining the first message, first system information associated with the first network node to the second network node; and
obtain, prior to obtaining the first message, second system information associated with the second network node, wherein the first type of system information comprises the first system information associated with the first network node, the second system information associated with the second network node, or any combination thereof.

8. The first network node of claim 1, wherein the transmission request message obtained from the second network node comprises the first portion of the first type of system information that is associated with the UE feature.

9. The first network node of claim 1, wherein the one or more processors are individually or collectively further operable to execute the code to cause the first network node to:
obtain one or more requests for system information associated with a second wireless cell, wherein the first network node is associated with a first wireless cell; and
output a report to the second network node indicating information associated with the one or more requests.

10. The first network node of claim 1, wherein the first message, the second message, the transmission request message, or any combination thereof indicates an identifier associated with the UE.

11. The first network node of claim 1, wherein the first portion of the first type of system information comprises system information associated with the first network node, the second network node, a third network node that is different from the first network node and the second network node, or any combination thereof.

12. The first network node of claim 1, wherein the one or more processors are individually or collectively operable to execute the code to cause the first network node to output the first portion of the first type of system information that is associated with the UE feature for unicast transmission, multicast transmission, broadcast transmission, or any combination thereof.

13. The first network node of claim 1, wherein the first message from the UE comprises a message 3 of a random access procedure.

14. A second network node, comprising:
one or more memories storing processor-executable code; and
one or more processors coupled with the one or more memories and individually or collectively operable to execute the code to cause the second network node to:
obtain a message from a first network node that requests a first type of system information and indicates a user equipment (UE) feature, the UE feature associated with a first portion of the first type of system information; and
output, to the first network node in response to obtaining the first message, a transmission request message that indicates for the first network node to output the first portion of the first type of system information that is associated with the UE feature.

15. The second network node of claim 14, wherein:
the first message further indicates a second UE feature, the second UE feature associated with a second portion of the first type of system information or with a first portion of a second type of system information; and
the transmission request message further indicates for the first network node to output the second portion of the first type of system information that is associated with the second UE feature.

16. The second network node of claim 14, wherein the one or more processors are individually or collectively further operable to execute the code to cause the second network node to:
obtain, prior to obtaining the first message, first system information associated with the first network node from the first network node; and
output, prior to obtaining the first message, second system information associated with the second network node to the first network node, wherein the first type of system information comprises the first system information associated with the first network node, the second system information associated with the second network node, or any combination thereof.

17. The second network node of claim 14, wherein the transmission request message output to the first network node comprises the first portion of the first type of system information that is associated with the UE feature.

18. The second network node of claim 14, wherein the one or more processors are individually or collectively further operable to execute the code to cause the second network node to:
obtain a report from the first network node indicating information associated with one or more requests obtained by the first network node for system information associated with a second wireless cell, wherein the first network node is associated with a first wireless cell.

19. The second network node of claim 14, wherein the first message, the transmission request message, or any combination thereof indicates an identifier associated with the UE.

20. A user equipment (UE), comprising:
one or more memories storing processor-executable code; and
one or more processors coupled with the one or more memories and individually or collectively operable to execute the code to cause the UE to:
transmit a message 3 of a random access procedure to a first network node, wherein the message 3 requests a first type of system information and indicates a UE feature, and wherein the UE feature is associated with a first portion of the first type of system information; and
receive the first portion of the first type of system information in response to transmitting the message 3.
